(19) United States
(12) Patent Application Publication
(10) Pub. No.: US 2025/0141042 A1
(43) Pub. Date: May 1, 2025

(54) Lithium-Ion Batteries Manufactured Using Paper Substrates

(71) Applicant: Northeastern University, Boston, MA (US)

(72) Inventors: Hongli Zhu, Newton, MA (US); Ying Wang, Boston, MA (US)

(21) Appl. No.: 18/837,109

(22) PCT Filed: Feb. 8, 2023
(86) PCT No.: PCT/US2023/062195

§ 371 Date: Aug. 8, 2024

Related U.S. Application Data
(60) Provisional application No. 63/267,786, filed on Feb. 9, 2022.

(51) Int. Cl. H01M 50/429; H01M 4/04; H01M 4/131; H01M 4/1391; H01M 4/58; H01M 4/62; H01M 4/66; H01M 10/0525; H01M 50/11; H01M 50/586

(52) U.S. Cl. CPC H01M 50/429; H01M 4/0404; H01M 4/131; H01M 4/1391; H01M 4/5825; H01M 4/62; H01M 4/661; H01M 10/0525; H01M 50/11; H01M 50/586

(57) ABSTRACT

Described herein is a lithium-ion battery comprising a cathode current collector, a cathode, a paper separator having a surface coated with an anti-shorting layer, an anode, and an anode current collector, wherein the cathode current collector is in contact with the cathode, the cathode is in contact with the paper separator, the paper separator is in contact with the anode, and the anode is in contact with the anode current collector. The lithium-ion battery can be fabricated by printing a cathode ink onto a first side of a paper separator having a surface coated with Al₂O₃, printing an anode ink onto a second side of said paper separator, printing a cathode current collector ink on the cathode, and printing an anode current collector ink on the anode.

### RELATED APPLICATION

This application claims the benefit of U.S. Provisional Application No. 63/267,786, filed on Feb. 9, 2022. The entire teachings of this application are incorporated herein by reference.

### GOVERNMENT SUPPORT

This invention was made with government support under Grant No. 1907250 awarded by the National Science Foundation. The government has certain rights in the invention.

### BACKGROUND

Lithium-ion batteries (LiBs) benefit from superior energy densities and are ubiquitously used in broad scales from microelectromechanical systems (MEMS), flexible electronics, portable electronics, electric vehicles, and large-scale grid storages. However, due to the geometrical limitations of microbatteries, their energy density is lower than traditional LiBs.

Traditional bar-coated battery industrialization cannot satisfy the high accuracy requirements for architecture-customized microbatteries. The published fabrication approaches, including three-dimensional (3D) printing, lithography, electrodeposition, and atomic layer deposition, are still limited to the laboratory demonstrative scale because of complex processes and unaffordable high prices.

Accordingly, there is a need for alternative processes, such as large-scale, roll-to-roll (R2R) flexographic printing processes, to fabricate microbatteries, such as pattern-integrated paper microbatteries.

### SUMMARY

Described herein is a lithium-ion battery comprising a cathode current collector, a cathode, a paper separator having a surface coated with an anti-shorting layer, an anode, and an anode current collector, wherein the cathode current collector is in contact with the cathode, the cathode is in contact with the paper separator, the paper separator is in contact with the anode, and the anode is in contact with the anode current collector.

Also described herein a method of fabricating a lithium-ion battery, comprising: printing cathode ink onto a first side of a paper separator having a surface coated with an anti-shorting layer and drying the cathode ink, thereby forming a cathode; printing anode ink onto a second side of the paper separator and drying the anode ink, thereby forming an anode; printing cathode current collector ink on the cathode; and printing anode current collector ink on the anode; thereby fabricating the battery.

Also described herein is a cathode ink comprising a lithium-based active material, a conductive additive, a binder, and an organic solvent, wherein the ink has a solid content that is about 20 wt. % to about 50 wt. % of the cathode ink.

Example advantages of the method of fabricating a lithium-ion battery described herein include:
This design combines two mature industrial production techniques, battery manufacturing, and traditional flexographic printing, to fulfill large-scale micro batteries manufacturing.
This design eliminates the electrolyte printing process, which removes a step of battery printing and significantly reduces the difficulty of recreating and industrial production.
Due to good ink absorption of the paper substrate, this design removes the wetting properties investigation between inks and current collector foils (generally, metal foils) and provides more room for recreating.
Comparing utilizing stainless steel foils (or other metal foils) as substrates, paper substrates are more flexible and foldable for flexible printed micro batteries, and cheaper and environmentally friendly in large-scale industrial manufacturing.
The paper substrate not only takes the function as printing substrate but also separator in the device.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the drawings included in the attached manuscript. The drawings are not necessarily to scale, emphasis instead being placed upon illustrating embodiments.

FIG. 1A is a schematic of materials and structural designs of pattern-integrated Li-ion paper batteries manufactured through flexographic printing.

FIG. 1B is a flow chart of a R2R multi-station flexographic printing system.

FIG. 1C is a photograph of a R2R multi-station flexographic printing system.

FIG. 1D is a photograph of a flexographic printing module with paper substrate.

FIG. 1E is a photograph of the rewinding process of a R2R flexographic printing machine with paper substrate.

FIG. 1F is a photograph of electrodes printed with various solid-content inks at multiple flexographic printing speeds.

FIG. 1G shows a complete cathode pattern printed with 35% solid-content ink at 80 inches per minute (in min⁻¹).

FIG. 2A is photographs of inks with 27%, 30%, 35%, and 40% solid contents, respectively, from left to right.

FIG. 2B is a plot of viscosity as a function of shear rate for the inks of FIG. 2A.

FIG. 2C is a plot of stress as a function of shear rate for the inks of FIG. 2A.

FIG. 2D shows contact angles of N-methylpyrrolidone (NMP) on both sides of paper (topside and underside) and Celgard.

FIG. 3A is a schematic of the stabilization effect of Al₂O₃ layer coated on paper during cycling.

FIG. 3B is a schematic of the layer configuration inside certain batteries described herein with the Al₂O₃-coated paper used as the separator.

FIG. 3C is a scanning electron microscopy (SEM) image of the underside of paper.

FIG. 3D is an SEM image of the topside of paper.

FIG. 3E is a low-magnification SEM image of the Al₂O₃ layer on the paper.

FIG. 3F is a high-magnification SEM image of the Al₂O₃ layer on the paper.

FIG. 3G is a low-magnification cross-sectional SEM image of the Al₂O₃ layer coated on the paper.

FIG. 3H is a high-magnification cross-sectional SEM image of the Al₂O₃ layer coated on the paper.

FIG. 3I is a Nyquist plot of Al₂O₃-coated paper battery (Al₂O₃-PB) and paper battery with commercial Celgard separator (PB-C).

FIG. 3J is a plot of discharge capacity as a function of cycle number, showing the rate performance of Al₂O₃-PB and PB-C.

FIG. 4A is a photograph of a flexographic printed cathode with paper pattern, manufactured with 35% solid-content ink at 80 in min-.

FIG. 4B is a cyclic voltammetry (CV) curve of flexographic printed R2R-Al₂O₃-PB at a scan rate of 0.1 mV·s⁻¹.

FIG. 4C is a Nyquist plot of R2R-Al₂O₃-PB and R2R-PB-C.

FIG. 4D is a plot of discharge capacity retention as a function of cycle number, showing the rate performance of R2R-Al₂O₃-PB and R2R-PB-C.

FIG. 4E shows the cycling performance of R2R-Al₂O₃-PB at 3° C. for 1,000 cycles.

FIG. 5A shows stress-strain curves of paper, Al₂O₃-coated paper, and Celgard.

FIG. 5B is photographs of fire-resistance tests of LiFePO₄ (LFP) paper electrodes (left two images) and Al₂O₃-coated paper with LFP electrodes (right two images).

FIG. 5C is photographs of the process of thermal shrinkage for Celgard, paper, and Al₂O₃-coated paper, upon exposure at 160° C. for 3 minutes.

FIG. 6 is a schematic of battery manufacturing processes with traditional bar coating technology, by which electrode slurries are coated on current collectors, then sandwiched with a layer of separator. Although widely used, this method cannot design and create particular patterns and architectures to fulfill unique needs.

FIG. 7A is a schematic of a flexographic printing module.

FIG. 7B is a photograph of the flexographic printing module of FIG. 7A.

FIG. 8 shows optical microscope images of flexographic printed patterns.

FIG. 9A is a photograph of a paper roll with a width of 6 inches, core diameter of 3 inches, and outside diameter of 4 inches.

FIG. 9B is a photograph of a manual ink proofer.

FIG. 10 shows contact angles of 35% solid content cathode ink on paper (topside and underside) and Celgard substrates measured by the Sessile drop method.

FIG. 11 shows transferred 27%, 30%, 35%, and 40% solid-content inks onto the topside of paper using a manual ink proofer.

FIG. 12 is SEM images of wood fibers at different magnifications.

FIG. 13 is a Nyquist plot of the battery with the bare paper as separator.

FIG. 14 is a schematic showing the process of printing the electrodes and current collectors in a pattern.

FIG. 15 is a diagram illustrating the benefits of the disclosed technology comprising a separator that is also the substrate (bottom schematic) versus a substrate that requires the separator/electrode to be added in the manufacturing process (top schematic). The disclosed technology reduces the pairs of rollers from five (top) to three (bottom), saves manufacturing time, is more efficient, and allows for higher alignment control between electrodes (cathode and anode) and current collectors.

### DETAILED DESCRIPTION

A description of example embodiments follows.

As a highly sophisticated industrial manufacturing process, roll-to-roll (R2R) printing technology provides continuity, high output, energy efficiency, and high controllability, which can be further modified and incorporated into existing battery manufacturing lines. More importantly, compared to the traditional battery manufacturing process, printing can integrate customized and high-resolution patterns into the electrodes. The special high-resolution pattern design satisfies the requirements of microbatteries manufacturing. The small shape of microbatteries can be widely applied in miniature electronic devices, such as MEMS, biosensors, body implants, microelectronics, smart cards, radio frequency identifiers, and integrated circuits.

Flexographic printing, a typical R2R printing process, utilizes a flexible relief plate to transfer inks on substrates. As the flexographic printing resolution is up to 3 μm, this technology can be used to accurately fabricate the electrodes with high resolution electrode architectures, further enhancing battery performance and inspiring new applications. For example, an electrode architecture design with low tortuosity and high porosity can increase the exposed ion transport channels, which is necessary for fast charging LiBs. Compared to gravure printing, the plate manufacturing of flexographic printing is facile and economic, as these plates are produced from inexpensive and flexible polymers. Moreover, functional ink preparation in flexographic printing is simpler than that in planographic printing, and flexographic printing can yield continuous printing lines and fine features compared to screen printing. Furthermore, flexographic printing can be used for printing almost any type of substrate at a high throughput and low cost.

Nonetheless, the substrate of flexographic printing is indispensable, and its printability and mechanical strength affect the printing quality. Thus, a suitable substrate for flexographic battery printing should display excellent ink wettability and absorbability to ensure adequate printability, bear high tensile strength to withstand the tension force during high-speed R2R manufacturing, and satisfy electrochemical stability during electrochemical cycling. Recently, aluminum foil was used as a printing substrate in a cathode electrode for a zinc-manganese (Zn—Mn) battery through flexographic printing. However, the low surface energy of aluminum foil resulted in poor printability and low resolution. In comparison to alternative electronic printing substrates such as metal, glass, plastic, and silicon wafer, paper exhibits excellent printability, high mechanical strength, admirable flexibility, high thermal stability, outstanding biodegradability, and economic efficiency, and it has been ubiquitously used in printing for centuries. More interestingly, the pores generated between the fibers in the paper can act as ion transfer paths in LiB separators. Meanwhile, unique intrinsic mesopores exist inside the cellulose fibers of paper, enabling excellent ink absorption for high-speed and high-precision printing apart from functioning as an electrolyte reservoir for LiB. Furthermore, the printed flexible and light-weight paper microbatteries can be integrated into wearable biosensors, artificial skin, MEMS, etc.

In this disclosure, flexographic printing to print LiB electrodes on paper was employed, and paper was used as a separator for the batteries. More specifically, a series of flexographic printable LiFePO₄ (LFP) cathode inks were developed, their rheological properties and printability were investigated, and the ink suitable for large-scale R2R flexographic printing was screened. After performing flexographic printing electrodes on paper, the performance of paper LiBs was modified and evaluated. Furthermore, the stable capacity retention of the flexographically printed paper battery at 3 C was tested for 1,000 cycles, which demonstrated the commercial potential of paper based R2R flexographically printed microbatteries.

As used herein, singular articles such as “a,” “an” and “the,” and similar referents are to be construed to cover both the singular and the plural, unless otherwise indicated herein or clearly contradicted by context. For example, reference to “a lithium-ion battery” may refer to one or more lithium-ion batteries. When a referent refers to the plural, the members of the plural can be the same as or different from one another.

“About” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of ±20%, e.g., ±10%, ±5% or ±1% of a given value. It is to be understood that the term “about” can precede any particular value specified herein, except for particular values used in the Exemplification.

### Lithium-Ion Batteries and Uses Thereof

Described herein is a lithium-ion battery comprising a cathode current collector, a cathode, a paper separator, an anode, and an anode current collector, wherein the cathode current collector is in contact with the cathode, the cathode is in contact with the paper separator, the paper separator is in contact with the anode, and the anode is in contact with the anode current collector. In some preferred aspects, the paper separator comprises a paper substrate having a surface coated with an anti-shorting layer.

As used herein, the term “current collector” refers to a material used to conduct electrons between an electrode active material (such as an anode or cathode) and the battery terminals. A current collector can be individually an anode current collector, a cathode current collector, or both.

In some aspects, the cathode current collector is a first metal foil. Examples of cathode current collectors can include: stainless steel, carbon, or aluminum (Al) metal or foil. In some aspects, the cathode current collector is aluminum (Al) foil.

In some aspects, the cathode current collector has a thickness of about 1 μm to about 100 μm, e.g., about 1 μm to about 50 μm, about 5 μm to about 100 μm, about 5 μm to about 50 μm, about 10 μm to about 100 μm, about 10 μm to about 50 μm. In some aspects, the cathode current collector has a thickness of about 5 μm to about 30 μm, e.g., about 5 μm, about 10 μm, about 15 μm, about 20 μm, about 25 μm, or about 30 μm. In some aspects, the cathode current collector has a thickness of about 20 μm.

As used herein, the term “cathode” refers to the battery electrode in which the reduction half-reaction occurs. Examples of cathode materials include: sulfur, Li metal oxides, polyanion oxides, stainless steel, LiNiₓMn_{y}Co_{z}O₂ where x+y+z is about 1 such as LiNi_{0.8}Mn_{0.1}Co_{0.1}O₂ (NMC811), LiNi_{0.6}Mn_{0.2}Co_{0.2}O₂ (NMC622), LiNi_{0.333}Mn_{0.333}Co_{0.333}O₂ (NMC111), and LiFePO₄. In some aspects, the cathode material comprises sulfur, Li metal oxides, polyanion oxides, stainless steel, LiNiₓMn_{y}Co_{z}O₂ where x+y+z is about 1 such as LiNi_{0.8}Mn_{0.1}Co_{0.1}O₂ (NMC811), LiNi_{0.6}Mn_{0.2}Co_{0.2}O₂ (NMC622), LiNi_{0.333}Mn_{0.333}Co_{0.333}O₂ (NMC111), or LiFePO₄, or any combination thereof. In some aspects, the cathode material comprises sulfur or a Li metal oxide. In some aspects, the cathode material comprises LiNiₓMn_{y}Co_{z}O₂ where x+y+z is about 1 such as LiNi_{0.8}Mn_{0.1}Co_{0.1}O₂ (NMC811), LiNi_{0.6}Mn_{0.2}Co_{0.2}O₂ (NMC622), or LiNi_{0.333}Mn_{0.333}Co_{0.333}O₂ (NMC111). In some aspects, the cathode material comprises LiFePO₄.

As used herein, the term “anode” refers to the battery electrode in which the oxidation half-reaction occurs. Examples of anode materials include: silicon, graphite, alloys comprising tin, cobalt, magnesium, silver, aluminum, and/or antimony, Li₄Ti₅O₁₂, amorphous carbon, silicon/carbon alloy, lithium oxalates, Li₂CO₃, or lithium (Li) metal or foil, or any combination thereof. In some aspects, the anode material comprises lithium (Li) foil.

In some aspects, the anode is in contact with the surface of the paper separator coated with an anti-shorting layer.

In some aspects, the anode current collector is a second metal foil. Examples of anode current collectors include: stainless steel or copper (Cu) metal or foil. In some aspects, the anode current collector is copper (Cu) foil.

In some aspects, the anode current collector has a thickness of about 1 μm to about 100 μm, e.g., about 1 μm to about 50 μm, about 5 μm to about 100 μm, about 5 μm to about 50 μm, about 10 μm to about 100 μm, about 10 μm to about 50 μm. In some aspects, the anode current collector has a thickness of about 5 μm to about 30 μm, e.g., about 5 μm, about 10 μm, about 15 μm, about 20 μm, about 25 μm, or about 30 μm. In some aspects, the anode current collector has a thickness of about 15 μm.

As used herein, the term “paper separator” refers to a paper substrate that separates the anode from the cathode in a battery described herein. In some aspects, the paper separator is flame-resistant, e.g., by virtue of being coated with a flame-resistant material, such as Al₂O₃.

“Paper substrate” refers to a plurality of fibers that have been pressed into thin sheets. The fibers are most typically fibers of cellulose, cotton, bamboo, wood, linen, or hemp, and can be naturally or synthetically derived. In some aspects, the paper substrate is cellulosic. In some aspects, the paper substrate is porous. In some aspects, the paper substrate has at least two types of pores, wherein a first type of pore is a macro pore or mesopore formed between fibers (e.g., cellulose fibers), and a second type of pore is a pore on the surface of fibers (e.g., cellulose fibers).

It will be appreciated that a paper substrate may have two identical sides or may have two distinguishable sides, as does, for example, the Bible paper described in the examples herein. When two sides of a paper substrate are distinguishable, it is typically due to the papermaking process, wherein one side of the paper substrate (the underside) contacted the wire on the papermaking machine, whereas the other side (the topside) contacted the air during manufacturing. In this process, generally, the topside is slightly smoother than the underside. In some aspects, a first side of the paper substrate and/or paper separator (e.g., the topside of the paper substrate) is smoother than a second side of the paper substrate and/or paper separator (e.g., the underside of the paper substrate). In some aspects, the cathode is in contact with the side of the paper separator corresponding to the topside of the paper substrate. In some aspects, the anode is in contact with the surface of the paper separator coated with an anti-shorting layer.

In order to facilitate use in the printing methods described herein, the paper separator and/or paper substrate should have adequate ink wettability and absorbability and bear high tensile strength. Thus, for example, in some aspects, the paper separator or paper substrate has a contact angle less than about 60°, e.g., less than about 50°, less than about 40°, less than about 20°, less than about 15°, and/or greater than about 10, e.g., greater than about 5°, as measured using a contact angle measuring instrument such as Huntech Co., LTD SDC-100. In some aspects, the paper separator or paper substrate has a contact angle less than the contact angle of a Celgard separator or paper substrate. In some aspects, the contact angle of the topside of the paper separator or paper substrate is the same as the contact angle of the underside of the paper separator or paper substrate. In some aspects, the contact angle of the topside of the paper separator or paper substrate is not the same as the contact angle of the underside of the paper separator or paper substrate. In some aspects, the topside of the paper separator or paper substrate has a contact angle of about 10.8°. In some aspects, the underside of the paper separator or paper substrate has a contact angle of about 8.9°. In some aspects, the paper separator or paper substrate has a tensile strength of at least 25 MPa, e.g., at least 30 MPa, at least 40 MPa, at least 50 MPa, at least 60 MPa, as measured by a universal testing machine (UTM). In some aspects, the paper separator or paper substrate has a tensile strength of about 62.9 MPa. In some aspects, the paper separator or paper substrate having an anti-shorting layer has a tensile strength of about 41.2 MPa.

To facilitate battery performance (e.g., power and energy density), it is desirable in some aspects that the paper separator and/or paper substrate be thin and/or lightweight. For example, in some aspects, the paper separator and/or paper substrate has a thickness of less than about 150 μm, e.g., less than about 100 μm, less than about 95 μm, less than about 75 μm, less than about 50 μm, less than about 35 μm, or about 25 μm, and/or greater than about 1 μm, e.g., greater than about 5 μm, greater than about 10 μm, greater than about 15 μm, or greater than about 20 μm. In alternative or further aspects, the paper separator and/or paper substrate has a weight of less than about 100 g/m², e.g., less than about 75 g/m², less than about 70 g/m², less than about 50 g/m², or less than about 35 g/m², and/or greater than about 5 g/m², e.g., greater than about 10 g/m², greater than about 15 g/m². For example, in alternative or further aspects, the paper separator and/or paper substrate has a weight of from about 20 g/m² to about 30 g/m² or about 20 g/m² to about 25 g/m². Bible paper, such as that described in the examples herein, is an example of a paper substrate having such characteristics.

In some aspects, the surface of the paper substrate coated with an anti-shorting layer is the underside of the paper substrate. In some aspects, the surface of the paper substrate coated with an anti-shorting layer is the topside of the paper substrate. In some aspects, the paper separator comprises a paper substrate coated on both sides with an anti-shorting layer. In some aspects, the anti-shorting layer comprises, consists of or consists essentially of (e.g., comprises) an inorganic material, such as Al₂O₃ or SiO₂. In some aspects, the anti-shorting layer comprises, consists of or consists essentially of (e.g., comprises) an organic material, such as nanocellulose. In some aspects, the anti-shorting layer comprises, consists of or consists essentially of (e.g., comprises) Al₂O₃ or SiO₂. In some aspects, the anti-shorting layer comprises, consists of or consists essentially of (e.g., comprises) Al₂O₃. It will be understood that when the paper separator has a surface coating comprising an anti-shorting layer that the coating is on the paper substrate that forms the paper separator.

As used herein, “anti-shorting layer” refers to a layer of porous material that inhibits short circuiting of a battery described herein. Without wishing to be bound by any particular theory, inhibition of short circuiting is believed to be due to inhibition by the porous material of penetration of cathode material (e.g., particles) through the paper separator and/or suppression of the penetration of lithium dendrites through the paper separator. The anti-shorting layer may also increase the ability to wet the paper substrate with a mixture comprising an electrolyte, which may enhance the ionic conductivity of the lithium-ion battery.

In some aspects, the anti-shorting layer (e.g., inorganic material, organic material) is in the form of a plurality of particles. In some aspects, the particles have a diameter of about 1 nanometer (nm) to about 1,000 nanometers, e.g., about 1 nm to about 100 nm, about 1 nm to about 500 nm, about 100 nm to about 500 nm, about 500 nm to about 1,000 nm, or about 750 nm to about 1,000 nm. In some aspects, the particles have a diameter of about 1 micron (μm) to about 1,000 microns, e.g., about 1 μm to about 100 μm, about 1 μm to about 500 μm, about 100 μm to about 500 μm, about 500 μm to about 1,000 μm, or about 750 μm to about 1,000 μm.

In some aspects, the anti-shorting layer has a thickness of about 1 μm to about 100 μm, e.g., about 1 μm to about 3 μm, about 1 μm to about 30 μm, about 1 μm to about 50 μm, about 5 μm to about 100 μm, about 5 μm to about 50 μm, about 10 μm to about 100 μm, about 10 μm to about 50 μm. In some aspects, the anti-shorting layer has a thickness of about 5 μm to about 30 μm, e.g., about 5 μm, about 10 μm, about 15 μm, about 20 μm, about 25 μm, or about 30 μm. In some aspects, the anti-shorting layer has a thickness of about 15 μm.

In some aspects, the lithium-ion battery is flexible.

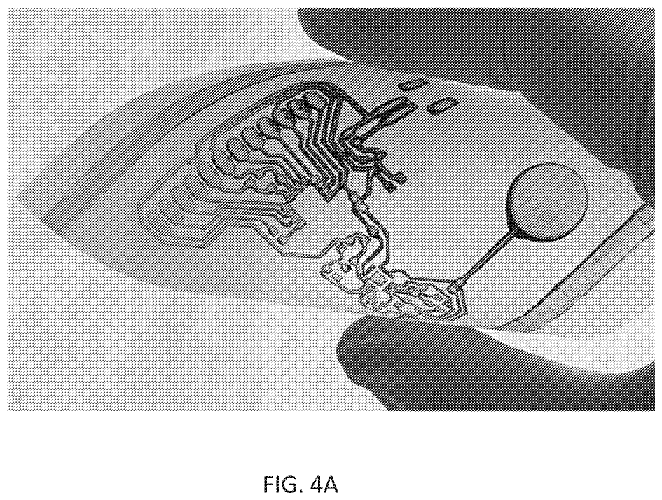

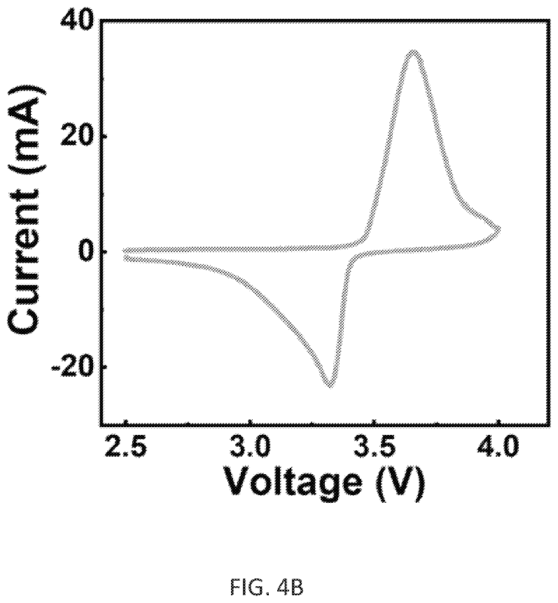

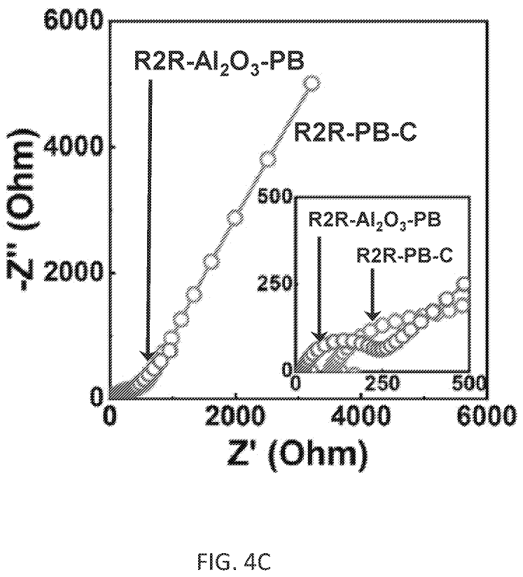

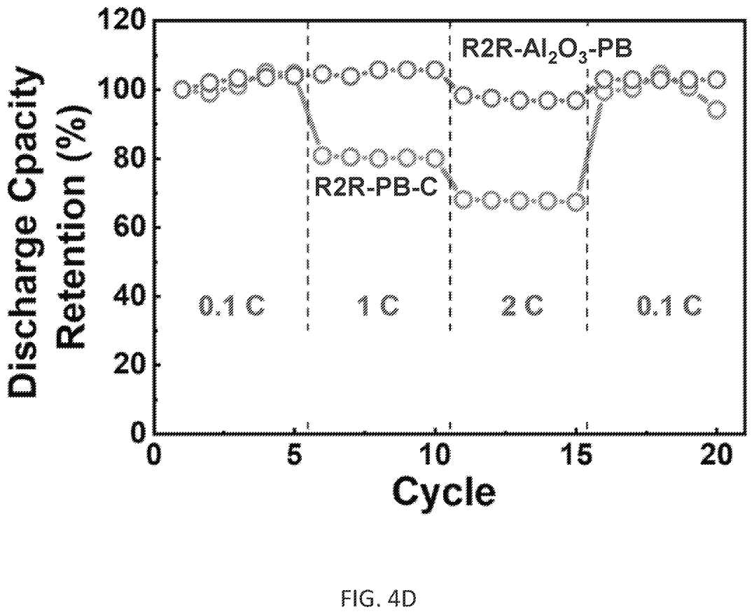

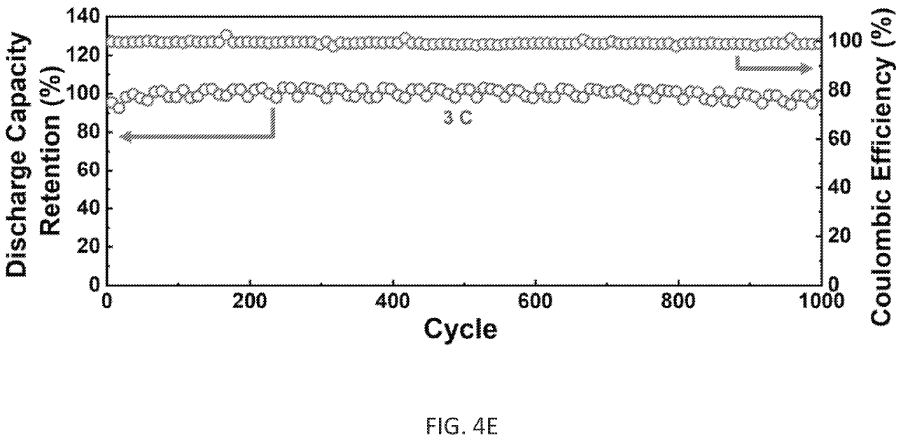

In some aspects, the lithium-ion battery is in the form of a microbattery, e.g., a two-dimensional microbattery, such as is depicted in FIG. 4A, or a three-dimensional microbattery, such as might be produced by printing the cathode in a three-dimensional pattern.

In some aspects, the cathode is in the form of a two-dimensional pattern. In some aspects, the cathode is in the form of a three-dimensional pattern. As used herein, the term “pattern” refers to any two- or three-dimensional design that can be printed using the flexographic printing methods described herein. The pattern or patterns can give architecture and structure to the battery, allow charge and/or ion transport within and between electrodes, and/or can create channels for a fluid electrolyte to flow through. The pattern or patterns for each of a current collector, cathode, electrolyte, and anode can be identical and aligned patterns or separately unique and non-aligning patterns. Typically, to support battery performance, in separately unique and non-aligning patterns, the layers maintain a point of contact with each other.

In some aspects, the cathode current collector, cathode, paper separator, anode, and anode current collector are contained in a sealed container (e.g., a coin cell) further containing liquid electrolyte. In further aspects, the sealed container is configured to permit contact between the paper separator and the liquid electrolyte. In yet further aspects, the paper separator is wet (e.g., saturated) with liquid electrolyte. In yet further aspects, the container further comprises metal (e.g., wire tabs) for external connection to the battery, such as connection of the battery to an energy source or an electrical device.

As used herein, the term “electrolyte” refers to a material that transfers ions or charge carrying particles between a battery's electrodes. Typically, in the batteries described herein, the electrolyte is liquid. Examples of electrolytes include: Li₆PS₅Cl, Li₇La₃Zr₂O₁₂ (LLZO), Li_{6.4}La₃Zr_{1.4}Ta_{0.6}O₁₂ (LLZTO), Li₃InCl₆, metal hydroxides, LiPF₆, sodium chloride, nitric acid, sulfuric acid, sodium acetate, chloric acid, ion-conducting polymers, and Al₂O₃ containing materials. In some aspects, the electrolyte is in the form of a liquid. In some aspects, the electrolyte is in the form of a solid.

In some aspects, the liquid electrolyte is LiPF6.

In some aspects, the lithium-ion battery further comprises metal (e.g., wire tabs) connected with the current collectors for external connection to the battery, such as connection of the battery to an energy source or an electrical device.

Charge or discharge capacity retention refers to a battery's ability to retain stored energy during a period of time. The charge and discharge capacities can be measured, for example, using LANDTH 8-channel tester, as described herein. In some aspects, the lithium-ion battery delivers a discharge capacity retention of about 100% at 1 C. In some aspects, the lithium-ion battery delivers a discharge capacity retention of about 97% at 2 C.

Coulombic efficiency is a measure of a battery's efficiency in transferring charge or ions. Coulombic efficiency can be calculated by dividing the delithiation capacity by the lithiation capacity and multiplying the resulting value by 100. In some aspects, the lithium-ion battery has a Coulombic efficiency of about 98% or greater.

In some aspects, the lithium-ion battery is a microbattery. Microbatteries are typically about 1 micron to about 25 millimeters in size and are typically used in bioengineering and/or artificial organs applications. In some aspects, the lithium-ion battery is a two-dimensional (2D) microbattery. In some aspects, the lithium-ion battery is a three-dimensional microbattery.

Also described herein is a system comprising a battery described herein connected to an energy source or an electrical device.

Examples uses of the lithium-ion batteries described herein include:
Microbatteries
Electronic skin
Electronic devices
Smart drug deliverable medicine
Sandwich structure devices
Paper batteries (e.g., low cost and sustainable one-time use paper batteries)
Smartphone (e.g., flexible, foldable, stretchable smartphone)
Microelectronic devices (e.g., flexible and wearable microelectronic devices)
Electronic clothes and electronic skin, e.g., which can be used as medical sensors.

### Methods of Making Lithium-Ion Batteries

Also described herein is a method of fabricating the lithium-ion batteries disclosed herein. In one aspect, the method comprises: printing cathode ink onto a first side (e.g., topside) of a paper separator and drying the cathode ink, thereby forming a cathode; printing anode ink onto a second side (e.g., underside) of the paper separator and drying the anode ink, thereby forming an anode; printing cathode current collector ink on the cathode; and printing anode current collector ink on the anode; thereby fabricating the battery. The cathode ink includes any of those described herein. In some aspects, the paper separator comprises a paper substrate having a surface coated with an anti-shorting layer. Used herein to describe various sides of a paper separator, “topside” and “underside” refer to the corresponding sides of the paper substrate which forms the paper separator.

It will be appreciated that, depending on the arrangement of the machinery used to effect printing, printing the cathode ink can precede, follow, or occur concurrently with printing the anode ink.

In some aspects, the cathode ink is a flexographic printable ink. In some aspects, the anode ink is a flexographic printable ink.

In some aspects, the printing is roll-to-roll flexographic printing.

As used herein, the term “flexographic printing” and/or “roll-to-roll flexographic printing” refers to a form of printing that uses a flexible relief plate to transfer ink onto a substrate.

In some aspects, the second side (e.g., underside) of the paper separator corresponds to the surface of the paper separator coated with an anti-shorting layer.

In some aspects, the cathode ink is printed in a two-dimensional or three-dimensional pattern.

Example uses of the method of fabricating a lithium-ion battery described herein include:
Large-scale flexible micro batteries manufacturing.
Large-scale fabricating electronic skin.
Large-scale fabricating other electronic devices.
Large-scale printing smart drug deliverable medicine
Large-scale printing sandwich structure devices.
Large-scale printing low cost and sustainable one-time use paper batteries.
Flexible, foldable, stretchable smartphone manufacturing.
Flexible and wearable micro electronic devices manufacturing.
Electronic clothes and electronic skin manufacturing, which can be used as medical sensors.
Battery packaging.

### Electrode Inks

Also described herein is a cathode ink comprising a lithium-based active material, a conductive additive, a binder, and an organic solvent, wherein the ink has a solid content that is about 20 wt. % to about 50 wt. % of the cathode ink.

In some aspects, the lithium-based active material, the conductive additive, and the binder in an organic solvent have a mass ratio of about 60:20:20 to about 95:3:2. In some aspects, the lithium-based active material, the conductive additive, and the binder in an organic solvent have a mass ratio of about 80:10:10.

In some aspects, the lithium-based active material is selected from the group consisting of sulfur, Li metal oxides, polyanion oxides, stainless steel, LiNiₓMn_{y}Co_{z}O₂ where x+y+z is about 1 such as LiNi_{0.8}Mn_{0.1}Co_{0.1}O₂ (NMC811), LiNi_{0.6}Mn_{0.2}Co_{0.2}O₂ (NMC622), LiNi_{0.333}Mn_{0.333}Co_{0.333}O₂ (NMC111), and LiFePO₄. In some aspects, the lithium-based active material is sulfur or a Li metal oxide. In some aspects, the lithium-based active material is LiNiₓMn_{y}Co_{z}O₂ where x+y+z is about 1 such as LiNi_{0.8}Mn_{0.1}Co_{0.1}O₂ (NMC811), LiNi_{0.6}Mn_{0.2}Co_{0.2}O₂ (NMC622), or LiNi_{0.333}Mn_{0.333}Co_{0.333}O₂ (NMC111). In some aspects, the lithium-based active material is LiFePO₄.

In some aspects, the lithium-based active material is in the form of particles. In some aspects, the lithium-based active material is in the form of particles having a size of about 1 nanometer to about 1,000 microns. In some aspects, the particles have a diameter of about 1 nanometer (nm) to about 1,000 nanometers, e.g., about 1 nm to about 100 nm, about 1 nm to about 500 nm, about 100 nm to about 500 nm, about 500 nm to about 1,000 nm, or about 750 nm to about 1,000 nm. In some aspects, the particles have a diameter of about 1 micron (μm) to about 1,000 microns, e.g., about 1 μm to about 100 μm, about 1 μm to about 500 μm, about 100 μm to about 500 μm, about 500 μm to about 1,000 μm, or about 750 μm to about 1,000 μm.

In some aspects, the solid content is about 20% to about 50% of the cathode ink dispersion, e.g., about 20% to about 40%, about 20% to about 30%, about 30% to about 40%, about 27%, about 30%, about 35%, or about 40%. In some aspects, the solid content is about 35% of the cathode ink dispersion. The solid content of the cathode ink dispersion can be calculated by dividing the total weight of solid or solids in the dispersion by the weight of the cathode ink. The solid or solids dispersed in the cathode ink dispersion may include the lithium-based active material, the conductive additive, and the binder. The organic solvent contributes to the weight of the cathode ink, but not the weight of the solid content.

Examples of conductive additives include: carbon black (sometimes referred to herein as super P), Ketjenblack, and vapor grown carbon fibers (or nanofibers) (VGCF). In some aspects, the conductive additive is selected from carbon black (sometimes referred to as super P), Ketjenblack, vapor grown carbon fibers or vapor grown carbon nanofibers (VGCF).

Examples of binders include: carboxymethyl cellulose (CMC), carboxymethyl cellulose lithium (CMC-Li), styrene butadiene rubber (SBR) copolymer, a solid permeable interface (SPI), and polyvinylidene fluoride (PVDF). In some aspects, the binder is CMC, CMC-Li, SBR copolymer, SPI, or PVDF. In some aspects, the binder is PVDF.

Examples of organic solvents include: alkyl solvents (such as hexanes, cyclohexane, pentanes, and the like), aromatic solvents (such as benzene, toluene, and the like), alcohols (such as acidic methanol, ethanol, and the like), esters, ethers, and ketones (such as diethyl ether, acetone, and the like), amines (such as dimethyl amine and the like), and nitrated and halogenated hydrocarbons (such as dichloromethane, acetonitrile, and the like), and polar aprotic solvents (such as 1-methyl-2-pyrrolidone (sometimes referred to herein as N-methylpyrrolidone, NMP), dimethylsulfoxide (DMSO), and the like). In some aspects, the organic solvent comprises a polar aprotic solvent (such as NMP, dimethylsulfoxide, dimethylformamide (DMF), and the like). In some aspects, the organic solvent is a polar aprotic solvent (such as NMP, dimethylsulfoxide, dimethylformamide (DMF), and the like). In some aspects, the organic solvent comprises dimethylformamide (DMF) or 1-methyl-2-pyrrolidone (NMP), or a combination thereof. In some aspects, the organic solvent is dimethylformamide (DMF) or 1-methyl-2-pyrrolidone (NMP), or a combination thereof. In some aspects, the organic solvent comprises NMP. In some aspects, the organic solvent is NMP.

The shear rate of a liquid, dispersion, or fluid is the rate at which layers of said liquid, dispersion, or fluid move past each other. The shear rate can be determined by the geometry and speed of the flow using a rheometer. In some aspects, the shear rate of the cathode ink is about 0.1 s⁻¹ to 1,000 s⁻¹ at 25° C. In some aspects, the shear rate of the cathode ink is about 0.1 s⁻¹ to 1 s⁻¹ at 25° C. In some aspects, the shear rate of the cathode ink is about 1 s⁻¹ to 1000 s⁻¹ at 25° C.

The viscosity of a liquid, dispersion, or fluid is a measure of its resistance to any deformation at a given rate. Viscosity can be measured using a viscometer or rheometer. In some aspects, the viscosity of the cathode ink is about 0.1 Pa s to about 1,000 Pa s at 25° C. In some aspects, the viscosity of the cathode ink is about 10 Pa s to about 1,000 Pa s at 25° C. In some aspects, the viscosity of the cathode ink is about 0.1 Pa s to about 2 Pa s at 25° C. In some aspects, the viscosity of the cathode ink is about 0.1 Pa s to about 1 Pa s at 25° C. In some aspects, the viscosity of the cathode ink is about 1 Pa s to about 2 Pa s at 25° C.

Yield stress of a material is the minimum stress that a material can undergo that causes permanent deformation. Yield stress can be measured using a rheometer. In some aspects, the yield stress of the cathode ink is about 1 Pa to about 100 Pa. In some aspects, the yield stress of the cathode ink is about 1 Pa to about 80 Pa.

### EXEMPLIFICATION

Electrode architectures significantly influence the electrochemical performance, flexibility, and applications of lithium-ion batteries (LiBs). However, the conventional bar coating for fabricating electrodes limits the addition of customized architecture or patterns. In this study, patterns were integrated into electrodes through large-scale roll-to-roll (R2R) flexographic printing. Additionally, flexible, recyclable, and biodegradable paper was used as a printing substrate during printing LiBs manufacturing, which exhibited superior printability. Moreover, the paper was modified with a thin-layer Al₂O₃ to function as the separator in the printed LiB. The Al₂O₃-coated paper enabled an admirable wettability for printing, excellent mechanical properties for high-speed R2R manufacturing, and outstanding thermal stability for the safe and stable operation of LiBs. The assembled paper cells exhibited nearly 100% discharge capacity retention after 1,000 cycles at 3 C and outstanding rate performance. This work inspires future large-scale microbatteries manufacturing integrated with high-resolution architecture designs.

The following data has been published in Wang, Y.; Cao, D.; Sun, X.; Ren, H.; Ji, T.; Jin, X.; Morse, J.; Stewart, B.; Zhu, H., Large-Scale Manufacturing of Pattern-Integrated Paper Li-ion Microbatteries through Roll-to-Roll Flexographic Printing, Advanced Materials Technologies 2022, 7, 2200303, the entire content of which is incorporated herein by reference.

### Example 1: Fabrication of Flexographic Printing Process

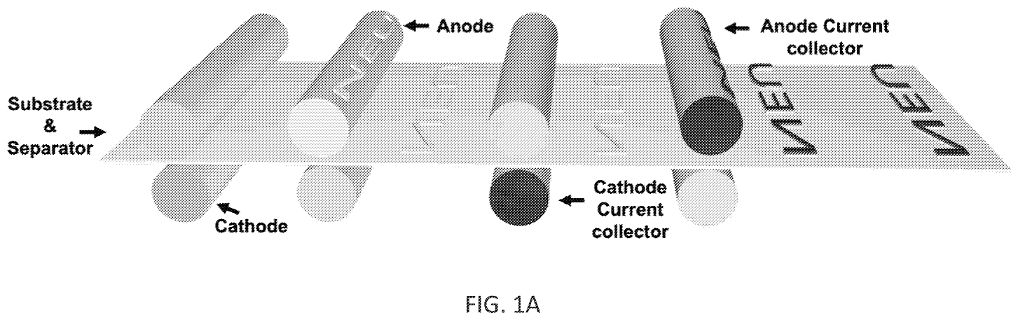

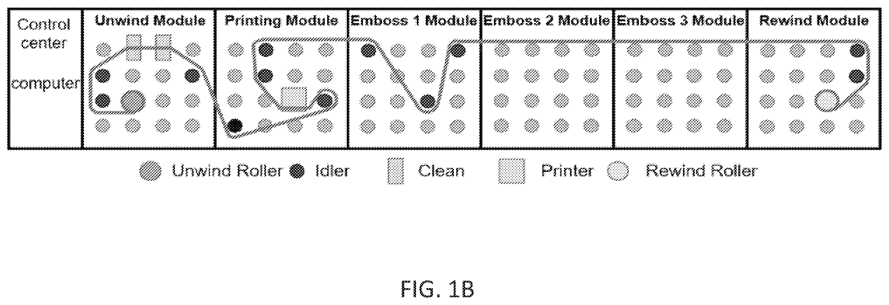

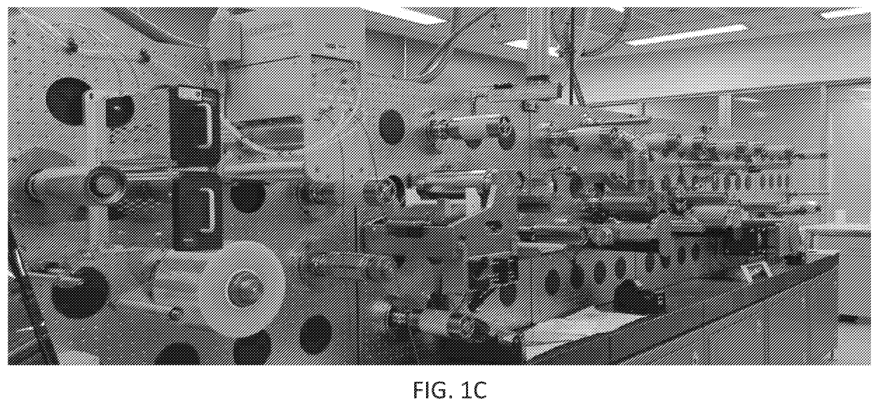

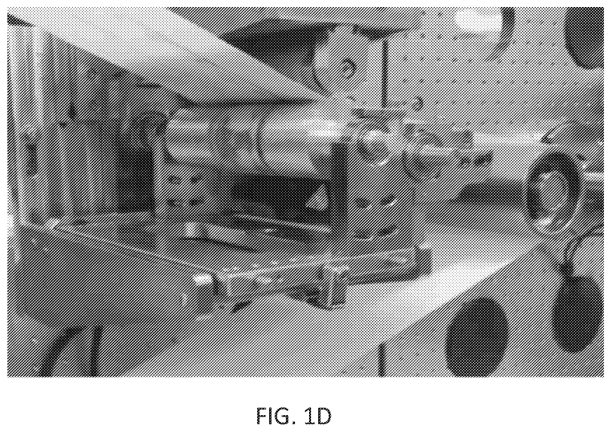

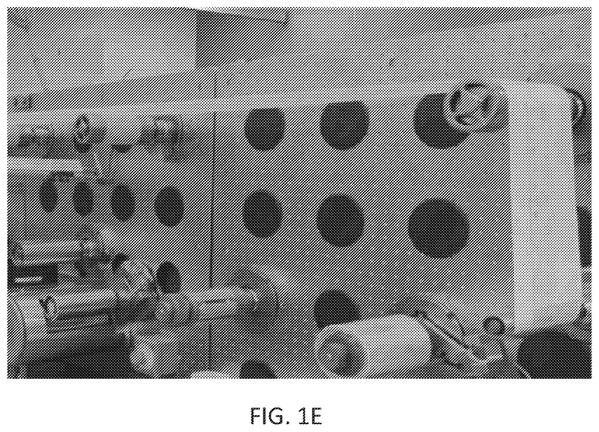

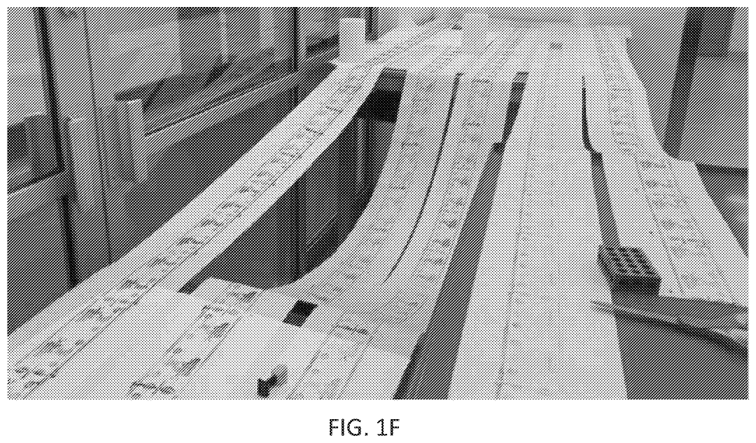

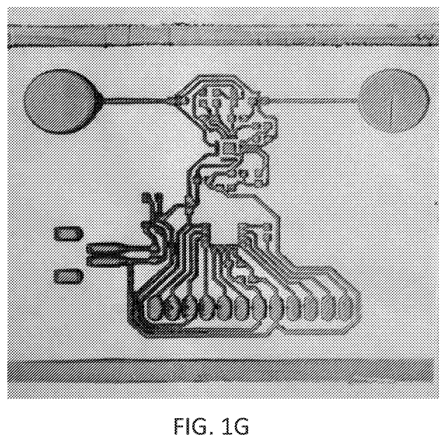

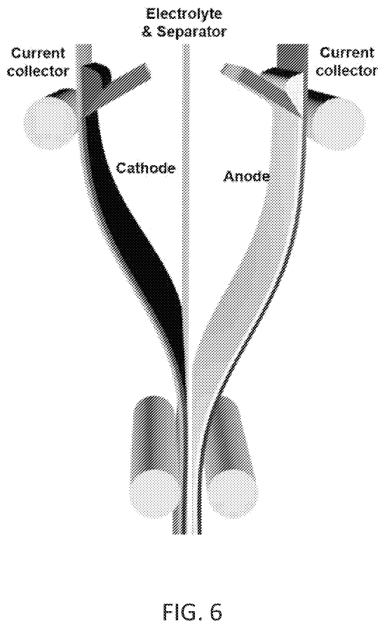

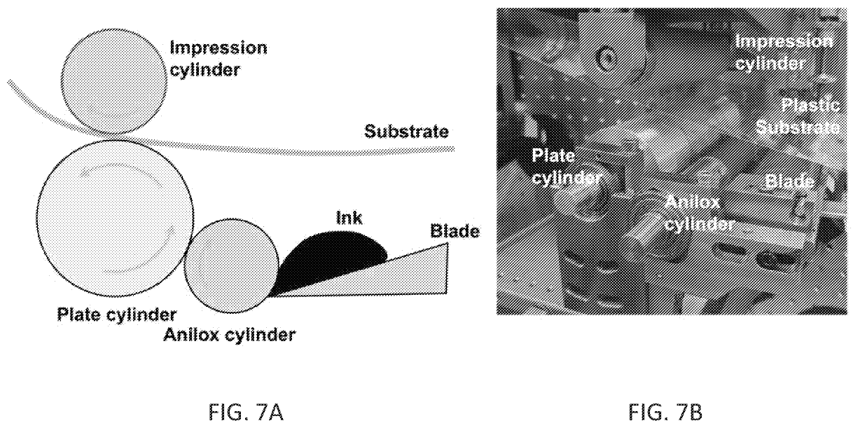

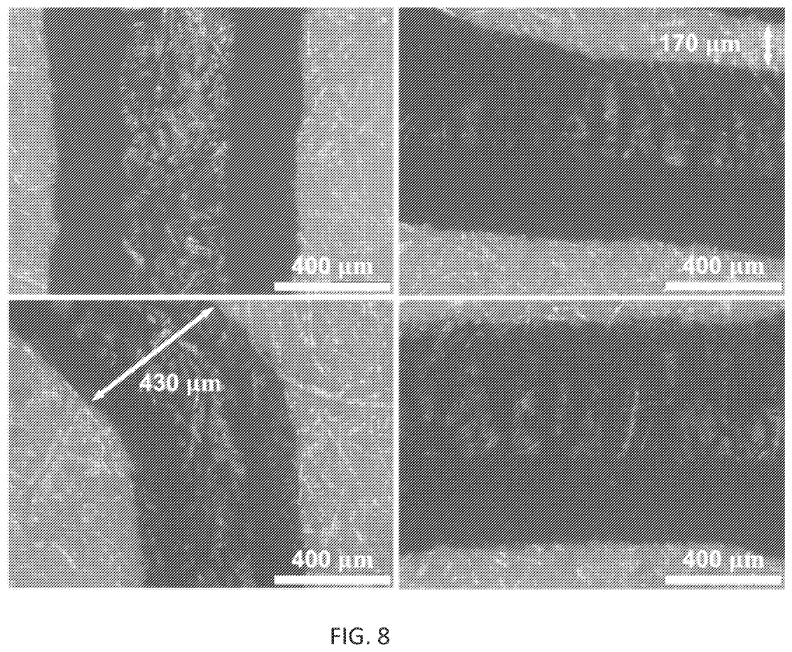

An example of a multistation flexographic printing process is illustrated in FIG. 1A. Through the process, the cathode and anode can be printed on each side of the paper, and the current collectors can be printed on top of the printed electrodes. Unlike the bar-coating battery manufacturing process depicted in FIG. 6, flexographic printing can be used to fabricate batteries integrated with customized patterns and separators at high manufacturing outputs with high energy and economic efficiency. The flowchart and corresponding image of the flexographic printing equipment used to produce the data described herein are presented in FIGS. 1B-C. The equipment was comprised of unwinding, printing, and rewinding modules, including unwind roller, idlers, cleaner setup, printer, and rewind roller in sequence. In FIG. 1B, the continuous blue line indicates the printing substrate (paper). The flexographic printing module with the paper substrate is displayed with magnification in FIG. 1D, and the components of the flexographic printing module (e.g., a blade, anilox cylinder, plate cylinder with the flexographic printing rubber plate, and an impression cylinder) are schematically represented in FIG. 7A and pictured in FIG. 7B. In particular, the ink was reserved in the slot located between the blade and anilox cylinder, wherein the blade scraped the anilox cylinder to ensure the uniform containment of the ink within the engraved cells on the anilox cylinder. Subsequently, the ink with uniform thickness was transferred onto the plate cylinder and then onto the substrate. The printing pressure and printing shear rate can be adjusted by controlling the distance between the plate cylinder and the impression cylinder. After the assembly of components, the developed ink was successfully transferred onto the paper with designed patterns from the flexographic printing plate and rewound, as displayed in FIG. 1E. The R2R, as-printed paper electrodes with fabricated LFP inks at various printing speeds are displayed in FIG. 1F. Moreover, the as-printed pattern integrated into the paper electrode is presented in FIG. 1G, and the details of the flexographic printed patterns observed under an optical microscope are illustrated in FIG. 8. Overall, the printed paper surface was flat and smooth and satisfied the requirement of the second-layer printing and alignment. Ideally, the resolution of this equipment is as high as 20 μm, which is sufficient relative to the size (e.g., 0.5-4 cm²) of two-dimensional (2D) microbatteries.

### Example 2: Development of Printable Cathode Ink

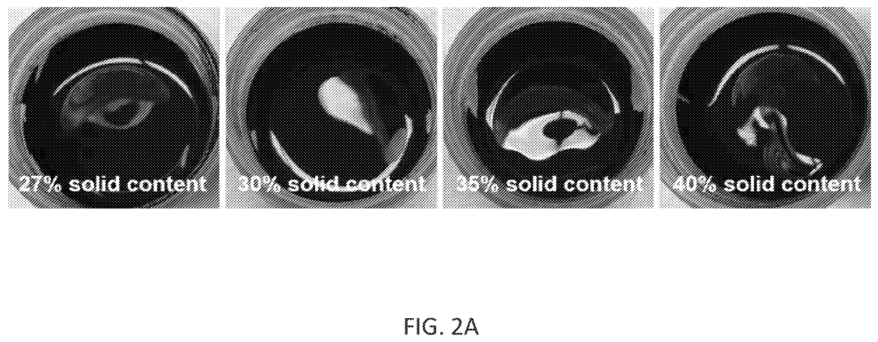

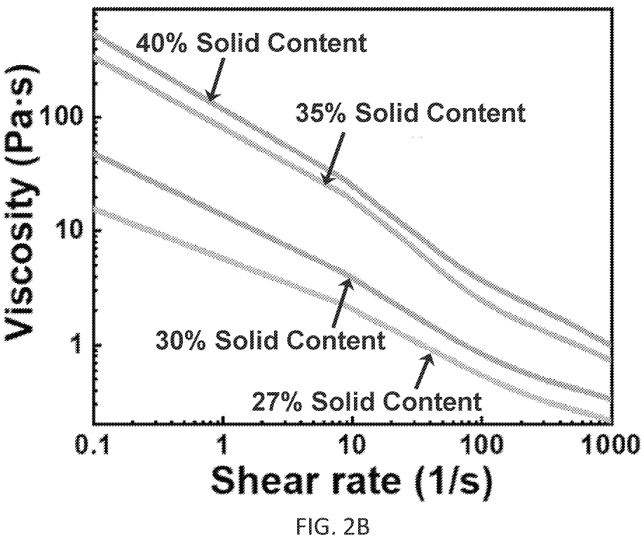

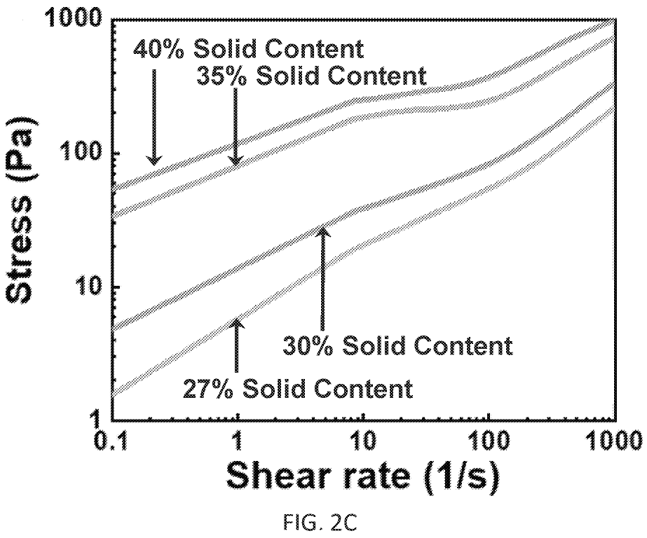

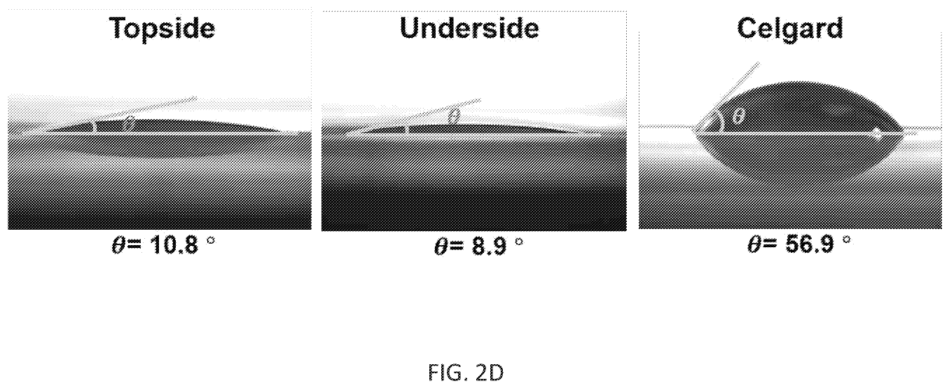

The development of inks with excellent printability is important to ensure successful printing. Accordingly, a series of cathode inks with varying solid contents were prepared for flexographic printing, and the inks, containing LFP (active material), super P (conductive additive), polyvinylidene fluoride (PVDF, binder), and 1-methyl-2-pyrrolidone (NMP, solvent) were further investigated. Inks having solid content of 27%, 30%, 35%, or 40% by weight were made, and their digital images are presented in FIG. 2A. The viscosity of the ink increased with its solid content. The dynamic viscosity and stress of inks with solid contents of 27%, 30%, 35%, or 40% solid content by weight with an increasing shear rate from 0.1 to 1,000 s⁻¹ are presented in FIGS. 2B and 2C, respectively. These rheological properties affected the printability of inks during high-speed R2R flexographic printing.

As observed in FIG. 2B, the viscosity of the ink decreased with the increasing shear rate, which demonstrated that all inks exhibited non-Newtonian shear-thinning behaviors. More importantly, inks with higher solid contents exhibited greater viscosity, and this variation in viscosity caused by the solid content was more pronounced at low shear rates. The viscosity of 40% solid-content ink was approximately 25 times larger than that of the 27% solid-content ink at 0.1 s⁻¹ shear rate and approximately 10 times larger for the 1,000 s⁻¹ shear rate. Overall, the viscosities of all inks were less than 2 Pa s for a shear rate larger than 10 s⁻¹, and the viscosity of all inks were less than 1 Pa s when the shear rate increased to 1000 s⁻¹. Ideally, the viscosity of the flexographic printable inks should be moderate to impede ink flow in the printing unit or reduce the amount of ink transferred per print, respectively. Specifically, the viscosities of the above-mentioned inks were all within the printable range of 1-2 Pa s at the typical operating shear rate for flexographic printing.

As depicted in FIG. 2C, all inks experienced yield stresses, beyond which the shear stress steadily increased with an increase in the shear rate, which implied that all inks behaved as Bingham plastic. Similar to viscosity, the yield stress of inks increased with their solid content, resulting from the more significant interaction of particles in high solid content inks. The yield stresses of all inks were less than 80 Pa, which satisfied the requirement of the flexographic printing machine used in this application.

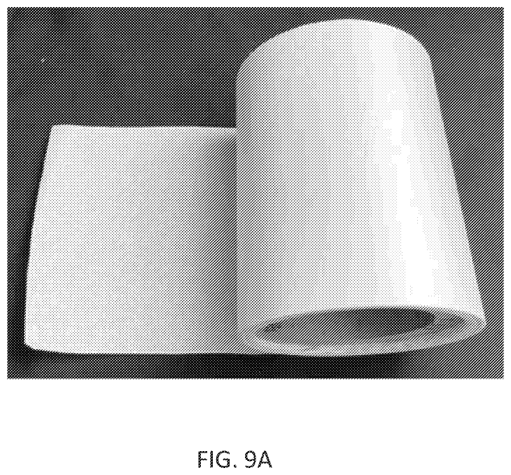

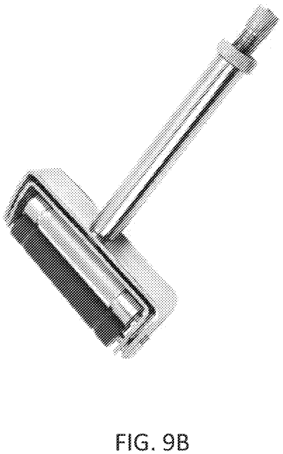

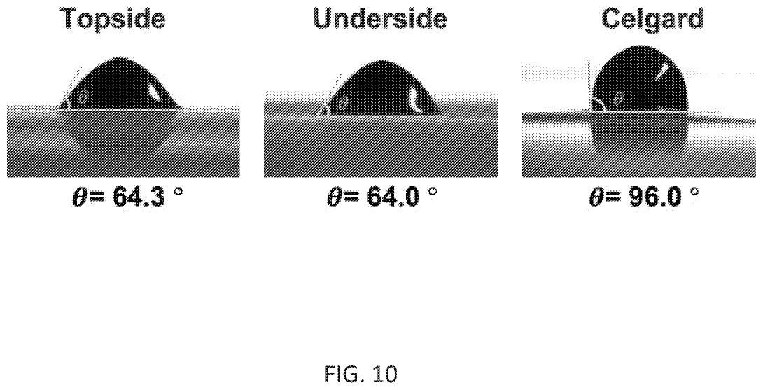

The substrate is another crucial element in printing, since the wettability, ink absorbability, and shape stability of substrate impact the printing quality. The excellent wettability of the substrate with ink is required for efficient ink transfer from the plate cylinder to the substrate, allowing the transfer of the ink in a short time, improving the quality of the printed pattern, and enhancing the contact between the printed electrodes and substrate, thus improving the cycling stability. In this application, an ultrathin (25 μm) R2R industrially produced commercial paper roll (FIG. 9A) was selected as the flexographic printing substrate. Due to the papermaking process, the paper had two sides (the underside and the topside). The underside contacted the wire on the papermaking machine, whereas the topside contacted the air during manufacturing. Generally, the topside was slightly smoother than the underside. The contact angle measurements were performed to evaluate the wettability of the paper with ink. The contact angles of N-methylpyrrolidone (NMP) with both sides of the paper are depicted in FIG. 2D along with the contact angle of NMP with the commercial separator from Celgard. Evidently, compared to the contact angle of the NMP on the Celgard separator of 56.9°, the paper surfaces created much smaller contact angles (about 10°) with the NMP, indicating the superior wetting of the ink with the paper. Although the NMP was hydrophobic and the cellulosic paper was hydrophilic, the mesoporous and hierarchically structured fibers of the paper imparted excellent solvent absorbability to it, because of which it is considered the gold standard of printing substrates throughout history. Contact angles of 35% solid-content LFP ink with both sides of the paper and Celgard substrates were measured using the Sessile drop method, as depicted in FIG. 10. From this study, the topside of the paper was selected as the printing surface for the cathode, considering the superior quality of the pattern printed on the smoother surface.

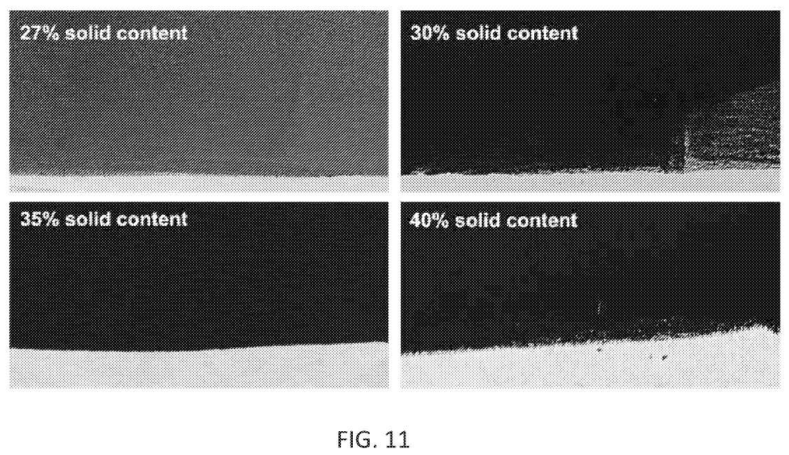

The manual ink proofer (FIG. 9B) was an evaluation tool for flexographic printable inks in bench-scale research. In this work, the proofer was preliminarily used to evaluate the matching between the ink and paper. The digital images of paper coated with 27%, 30%, 35%, and 40% solid-content inks through the manual ink proofer are shown in FIG. 11. All inks were easily transferred onto the paper, among which the 35% solid-content LFP ink exhibited the best printing quality, including sharp edges, uniform printing surface, and a complete coverage due to the appropriate viscosity, as discussed earlier. In addition to the ink's rheological properties, the electrode printing quality was influenced by the printing velocity in real R2R flexographic printing. Thus, to achieve the most suitable printing quality, several trials were conducted on the flexographic printing equipment. The 35% solid-content LFP ink exhibited the most suitable printing quality on the topside of the as-received paper utilizing a flexographic printing machine at 80 in/min.

### Example 3: Coating Al₂O₃ on Paper Substrate

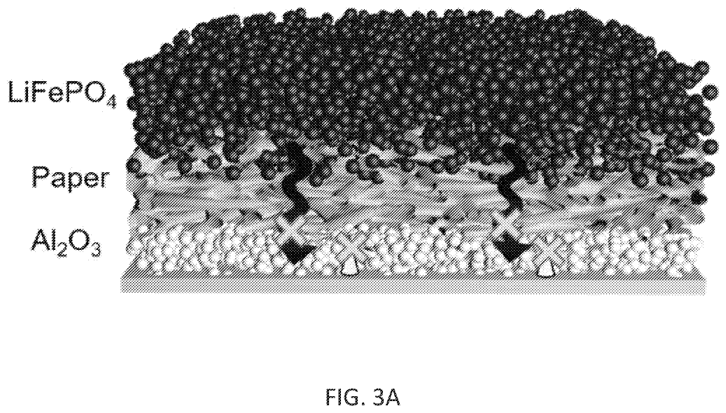

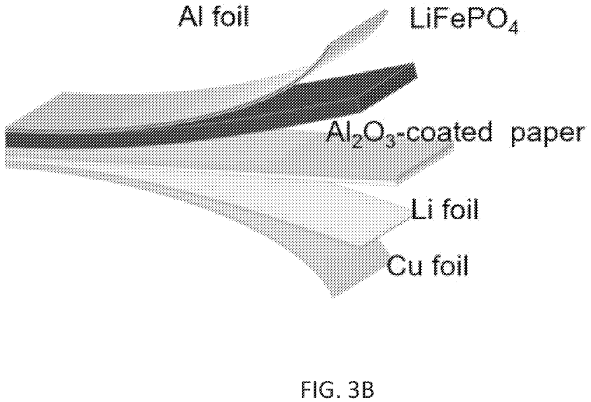

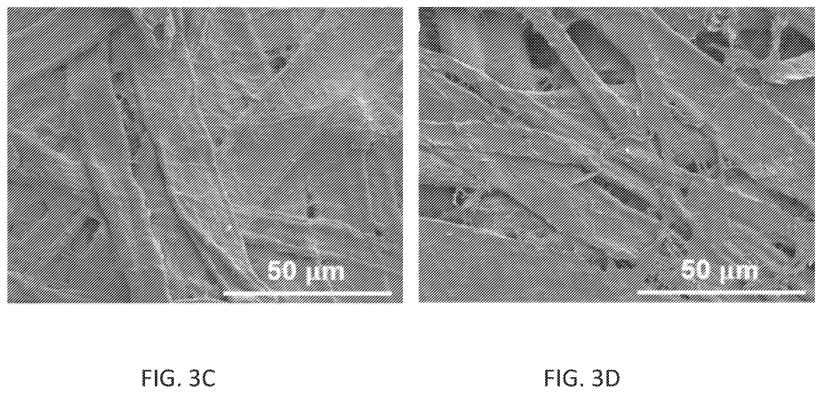

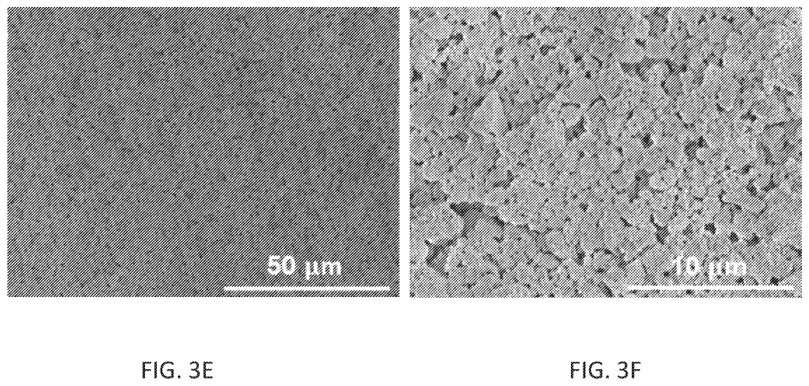

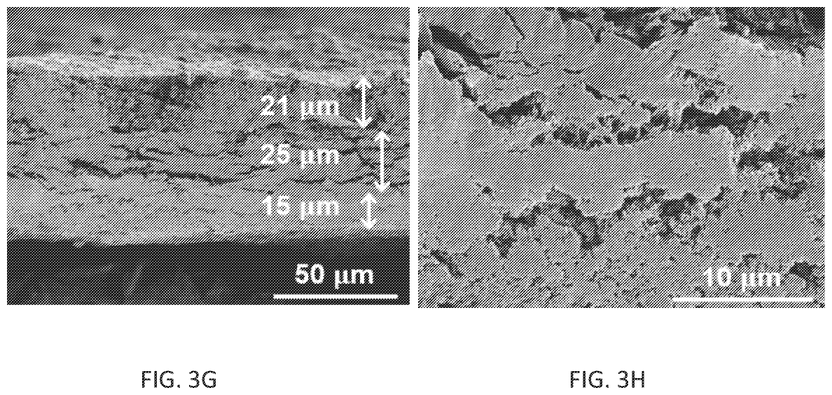

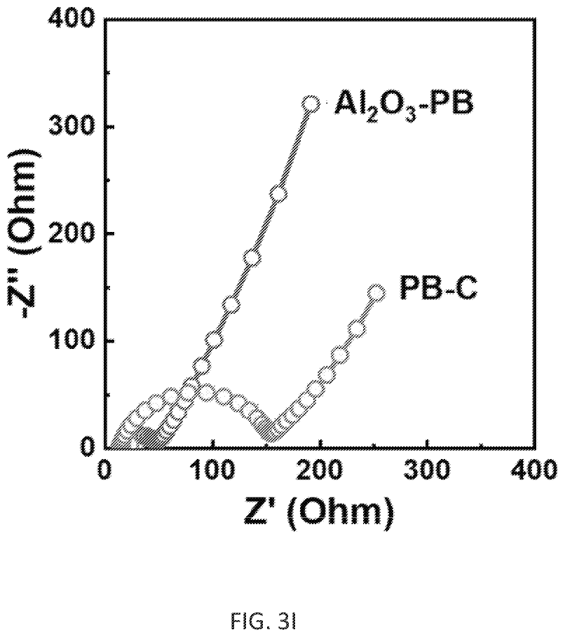

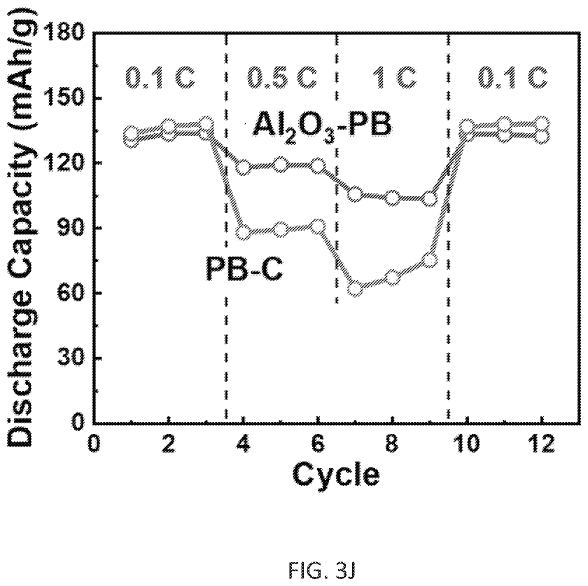

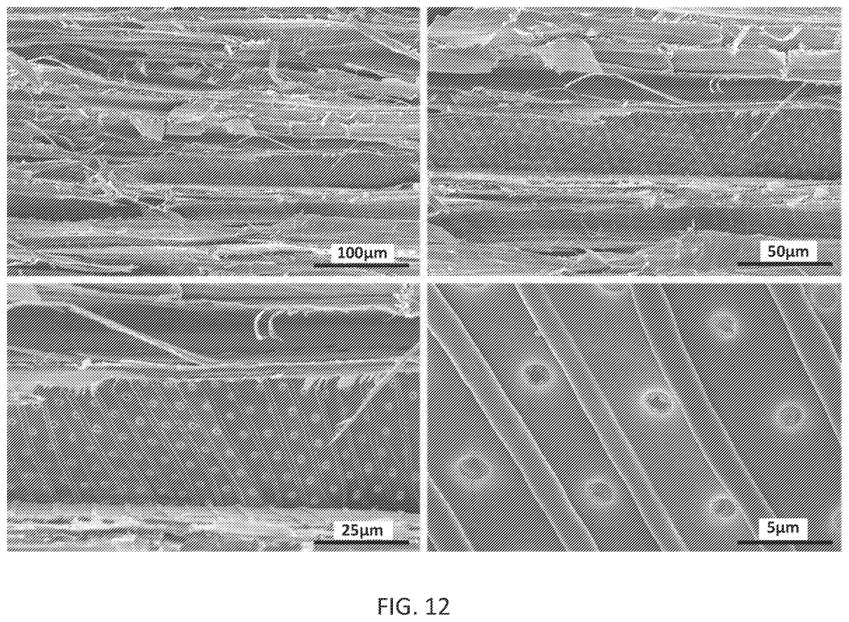

Paper is a suitable substrate for printing owing to its excellent ink absorbability and superior mechanical flexibility. Concurrently, cellulosic paper can be used as an ion transportation membrane due to its intrinsic porous structure and high electrochemical stability. In this application, paper acted as both the printing substrate and the battery separator. In particular, the paper contained two levels of pores: 1) macro pores formed between the cellulose fiber; 2) holes and pores on the natural fibers (FIG. 12). Moreover, paper is sustainable, lightweight, and affordable. To prevent the printed cathode particles from penetrating the thin paper and causing short circuits, an additional thin layer of Al₂O₃ was coated on the other side of the paper. Al₂O₃ is an electrochemical and thermally stable material. Besides rendering the adequate cycling performance of paper LiBs, the Al₂O₃ coating layer can improve the wetting of separator and electrolyte, therefore enhancing the ionic conductivity of LiBs and rate performance. The schematic in FIG. 3A illustrates the purposes of coating the dense and hard Al₂O₃ layer, namely, to prevent: 1) the penetration of LFP particles through the first level of pores between fibers, and 2) the potential suppression of the Li dendrites penetration by the hard Al₂O₃ layer. The configuration of the layers inside the batteries with the Al₂O₃-coated paper as the separator is presented in FIG. 3B, wherein the LFP and Li metal are separated on both sides of the Al₂O₃-coated paper.

Scanning electron microscopy (SEM) was used to characterize the morphologies of the as-received paper and Al₂O₃-coated paper. The two sides of the selected paper (underside and topside) are separately displayed in FIGS. 3C and 3D, respectively. As observed, the width of the fibers ranged between about 15-25 μm, with several first-level pores generated by the irregular stacking of fibers. Along with the mesoscale pores from natural hierarchical fibrous structure, these pores established the channels required for the transfer of Li-ions during cycling. The magnified images of the Al₂O₃-coated surface are presented in FIGS. 3E and 3F, which depict that the Al₂O₃ nanoparticles completely covered the paper fibers and created numerous tiny pores for Li-ion transferring. In addition, the cross-section of the LFP-paper-Al₂O₃ layer is illustrated in FIG. 3G, wherein the LFP ink was coated on one side of the paper using the manual ink proofer, and an Al₂O₃ layer was coated on the other side by the Mayer rod. Overall, the paper thickness was about 25 μm, and the Al₂O₃ layer was about 15 μm. The magnified image of the interface between the paper and Al₂O₃ layer is displayed in FIG. 3H, which portrays the Al₂O₃ layer with no significant boundary between the paper fibers and Al₂O₃ layer, thereby signifying an appropriate integration of the paper with Al₂O₃.

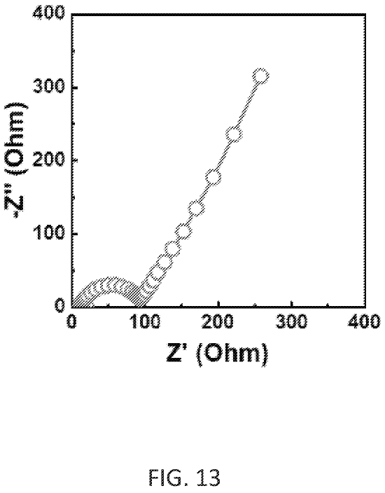

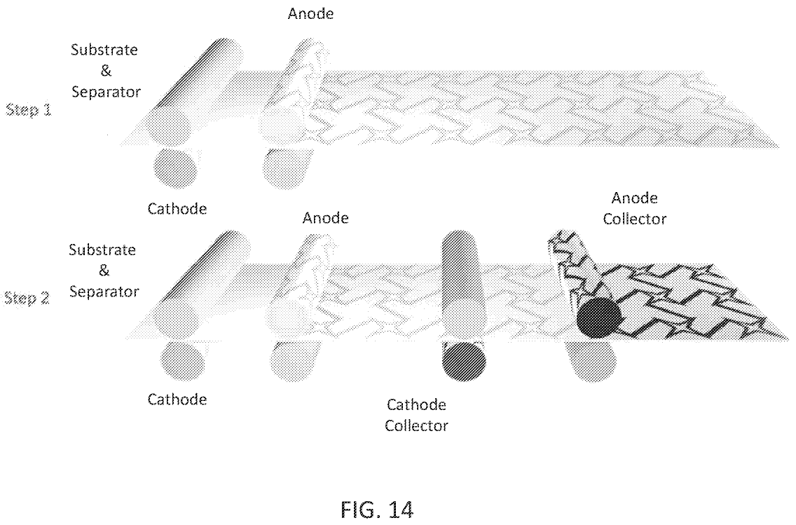

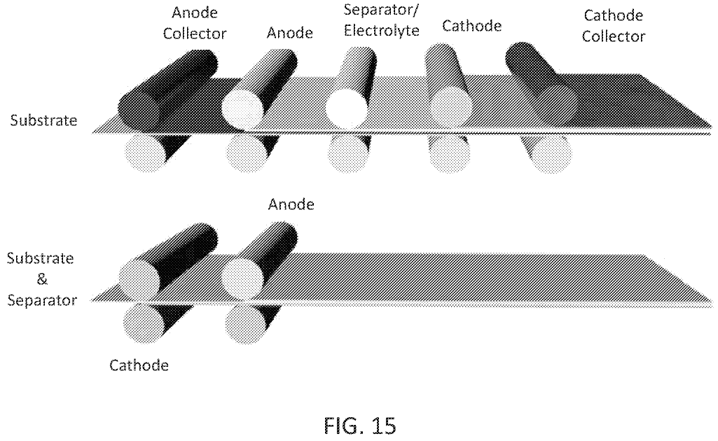

The function of the Al₂O₃ layer for the paper electrode was validated and evaluated based on a comparative analysis of the electrochemical performances of the Al₂O₃-coated paper batteries (Al₂O₃-PB) and the paper electrode with the commercial Celgard separator (PB-C, control sample). The Nyquist plots of the Al₂O₃-PB and control sample are presented in FIG. 3I, wherein the semicircle diameter at the high-frequency region represents the charge transfer resistance. As compared to the half-cell with the bare paper used as the separator (FIG. 13), the order of charge transfer resistance of the cell using these separators was obtained as follows: Al₂O₃-coated paper (34.4Ω)<bare paper (101.1Ω)<paper and Celgard (140.3Ω). The lower charge transfer resistance of a cell with the Al₂O₃-coated paper was caused by the improved ionic conductivity resulting from the pores between the Al₂O₃ particles (FIG. 3F) and an improved thermal stability. The specific discharge capacities of the half-cells with the Al₂O₃-coated paper and Celgard used as separators with a current density ranging from 0.1 C to 1 C are depicted in FIG. 3J. Although the discharge capacities of the two half-cells were similar at 0.1 C (132.7 and 136.2 mAh/g), the Al₂O₃-PB displayed higher specific discharge capacities at 0.5 C (118.7 versus 89.5 mAh/g). Moreover, the discharge capacities of Al₂O₃-PB (104.4 mAh/g) were more than 1.5 times those of the PB-C (68.3 mAh/g) at 1 C, resulting from that the charge transfer resistance of Al₂O₃-PB being less than that of the control sample.

### Example 4: Performance of Flexographically Printed Paper Electrodes

After modifying and optimizing the ink and substrate with the bench-scale manual ink proofer, the 35% and 40% solid-content LFP inks and paper substrate were employed in the large-scale R2R printing machine. A digital image of the printed paper electrode with 35% solid-content ink at a flexographic printing speed of 80 in/min is portrayed in FIG. 4A. As observed, the printed electrode was flexible with a complex pattern on a paper substrate. In addition, the electrochemical performances of the flexographically printed paper electrodes were evaluated in coin cells using Al₂O₃-coated paper (R2R-Al₂O₃-PB) and Celgard (R2R-PB-C, control sample) as separators. The assembly of R2R-PB-C was similar to that of PB-C. The cyclic voltammogram (CV) of the R2R-Al₂O₃-PB (FIG. 4B) exhibited a pair of symmetrical anodic/cathodic peaks. Specifically, the anodic and cathodic peaks were located at 3.678 and 3.319 V, respectively, indicating a potential gap of 359 mV corresponding to the oxidation and reduction transformation between Fe²⁺ and Fe³⁺. Moreover, the presence of no additional anodic/cathodic peaks indicated the absence of side reactions.

The Nyquist plots of the R2R-Al₂O₃-PB and R2R-PB-C are presented in FIG. 4C, which display semicircles followed by the Warburg tails. Compared to R2R-PB-C, the R2R-Al₂O₃-PB exhibited low bulk resistance (20.7 vs. 100.7Ω), less charge transfer resistance (237.5 vs. 517.4Ω), and a low slope implying relatively rapid Li-ion diffusion. The discharge capacity retention of the R2R-Al₂O₃-PB at varying rates is presented in FIG. 4D. Similar to the previous data (FIG. 3J), the discharge capacity retention of R2R-Al₂O₃-PB was much higher than that of R2R-PB-C, especially at high rates (100.0% versus 79.8% at 1 C and 97.2% versus 67.7% at 2 C). The long-term cycling performance of R2R-Al₂O₃-PB at a current density of 3 C is presented in FIG. 4E, wherein activation was performed at C/3 for the initial six cycles. The R2R-Al₂O₃-PB cell maintained stability after 1,000 cycles with approximately 100% discharge capacity retention at 3 C and Coulombic efficiency of greater than 98%. Thus far, the Al₂O₃ layer coating on the paper surface increased the cycle stability for flexographic printed batteries and improved the rate performances in comparison to the addition of Celgard in the paper battery. All the profiles demonstrated the potential of integrating R2R flexographic printing manufacturing for pattern designs for LiBs.

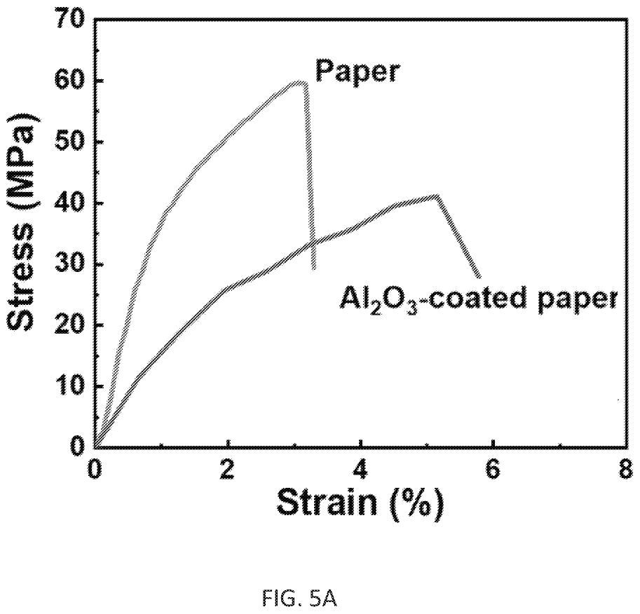

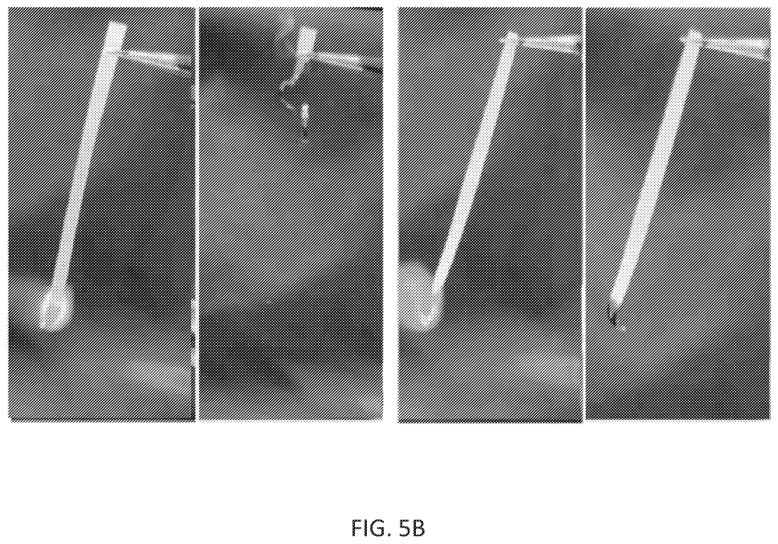

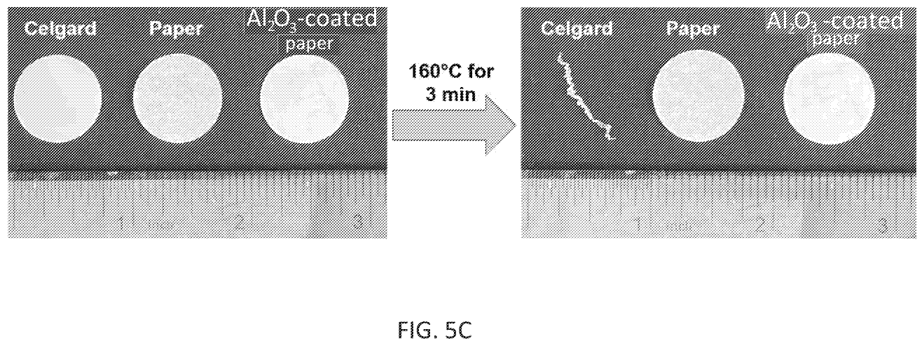

In addition to the above-mentioned advantages of paper as a substrate and separator in flexographic printed LiB manufacturing, the paper offered outstanding mechanical strength for high-output R2R manufacturing and superior thermal stability for high-safety LiBs compared to commercial polymer separators. During high-speed manufacturing, the high tension from the R2R machine may impair the substrate structure or even tear the substrate. Therefore, the substrates require high tensile strength to withstand the tension from rollers during high-speed R2R manufacturing. The stress-strain curves of paper and Al₂O₃-coated paper are plotted in FIG. 5A. As derived, the tensile strength of the paper was 62.9 MPa, which decreased to 41.2 MPa after coating the Al₂O₃ layer due to the lower tensile strength of the Al₂O₃ layer than those of cellulose fibers. However, the Al₂O₃-coated paper in this application still exhibited a much higher tensile strength than the reported paper-based separators.

As a common fire-resistant material, Al₂O₃ can prevent or retard the spread of flames to the LFP paper electrode. As depicted in FIG. 5B, ignition tests were conducted for the LFP and LFP Al₂O₃-coated paper electrodes, and the samples were ignited with the highest flame temperature of 1,400° C. from a butane flame gun. Upon approaching the outer flame, the LFP paper electrode was ignited and entirely engulfed in flame within 3 seconds. Comparatively, the self-extinguishing behavior was observed for the LFP Al₂O₃-coated paper electrode, signifying its outstanding flame resistance. Furthermore, the dimensional thermal stability of the LiB separator is essential because shrinking and wrinkling at high temperatures can result in a short circuit or even an explosion. The dimensional thermal stabilities of Celgard, paper, and Al₂O₃-coated paper were comparatively evaluated based on the area shrinkage before and after thermal exposure at 160° C. for 3 minutes. As exemplified in FIG. 5C, the Celgard substrate vigorously shrank to a line, whereas both paper and Al₂O₃-coated paper displayed no shrinkage at 160° C. Therefore, the excellent flame resistance and dimensional thermal stability gave the Al₂O₃-coated paper excellent thermal safety during application.

### Example 5: Summary

In this disclosure, patterns were integrated onto the Li-ion electrode using large-scale R2R flexographic printing and paper as both the printing substrate and battery separator. Flexographic inks that behaved as shear-thinning Bingham plastic were also developed. The ink was successfully printed onto the selected paper using a real flexographic machine to produce high-resolution pattern-integrated electrodes. Moreover, a thin layer of Al₂O₃ was coated on paper to resolve the issue of short circuiting that can arise upon using paper as both a printing substrate and battery separator. Consequently, the R2R-Al₂O₃-PB exhibited a relatively improved rate performance (97.2% discharge capacity retention at 2 C relative to that at 0.1 C) and outstanding capacity stability (about 100% discharge capacity retention after 1000 cycles at 3 C). This work may allow large scale and economically printing of flexible paper microbatteries through R2R high speed flexographic printing for MEMS, wearable medical devices, artificial organs, and energy built into chips.

### Example 6: Materials

LiFePO₄ (LFP) and 1-Methyl-2-pyrrolidinone (NMP) were purchased from Fisher Science Education. Al₂O₃ particles were purchased from Mark V Laboratory. Super P was purchased from MTI Corporation. Polyvinylidene fluoride (PVDF) was purchased from Sigma-Aldrich for ink preparation and Nanoramic Laboratories for Al₂O₃ slurry preparation. Before the utilization, PVDF was dissolved into NMP at room temperature. The paper roll with a width of 6 inches, core diameter of 3 inches, and an external diameter of 4 inches was purchased from Zhongchang Paper Co. (Dongguan, China). All chemicals and materials were used as received.

### Example 7: Paper Substrate Modification

The commercial Bible paper was selected as the substrate. The Bible paper was thin, light, strong, meticulous, dense, and smooth. The paper was slightly transparent and had a certain degree of water resistance. When applied as separator in battery, the thin (25 μm) and lightweight (23.4 g/m²) Bible paper provided superior power and energy density compared to thick (97 μm) and heavyweight (75.2 g/m²) commercial copy paper. Al₂O₃ slurry was fabricated by mixing Al₂O₃ and PVDF in a mass ratio of 7:3. In detail, Al₂O₃ particles were initially suspended in NMP and mixed with 10 wt. % PVDF/NMP using a dual asymmetric centrifugal mechanism at 3,500 rpm for 5 minutes. The solid content of the Al₂O₃ slurry was modified into 15 wt. %. Thereafter, the 0.02-inch-thick layer was first coated on the blank side of the paper electrode using a Mayer rod (#20 wire wound rod from R.D. Specialties). After drying at 80° C. for 8 hours, an additional 0.02-inch-thick layer was coated on the blank side of the paper. The Al₂O₃ particles used in this application were small (diameter of about 50 nm) and low price ($58/pound) and had the potential to be applied in large-scale R2R flexographic manufacturing.

### Example 8: Preparation of LiFePO₄ (LFP) Ink

Typically, the LFP ink was prepared by mixing LFP, super P, and PVDF in a mass ratio of 8:1:1 (sometimes referred to herein as 80:10:10) in NMP. The super P, LFP, and 10 wt. % PVDF/NMP were added step-by-step and mixed using a dual asymmetric centrifugal mechanism (DAC 330-100 Pro Speedmixer from FlakTek) at 3,500 rpm for 5 minutes.

### Example 9: Electrode Preparation

In laboratory-scale paper electrode fabrication, an LFP ink layer of 0.03 inches in thickness was coated on the topside of the paper by Mayer rod (#30 wire wound rod from R.D. Specialties) in the laboratory, after which the paper electrode was dried at 80° C. for 8 hours. The mass loading of LFP was about 3.55 mg/cm². The R2R-scale paper electrode was fabricated using the NIL tool of the R2R rotary trail process with the flexographic printing cylinder (i722=315.335; i822=334.255) at the Core R2R Facility, UMass Amherst, USA. In particular, 35% and 40% solid content ink were flexographically printed on both sides of the paper with a line speed of 20 in/min and 80 in/min at 25° C. Specifically, the unwind and rewind forces were adjusted to 1.6 lbs. and 1.0 lbs, respectively to ensure the quality of the printed pattern and the flatness of the printing surface. The printed electrode was air-dried for 4 hours at room temperature and subsequently transferred to the oven at 80° C. for 8 hours.

### Example 10: Characterization Methods

The morphology of the samples was observed using a scanning electron microscope (SEM; Hitachi S4800 SEM) at 3 kV. The rheological properties of the ink and the mechanical properties of the films were measured using a hybrid rheometer (Discovery HR-30, TA-Instruments). For rheological properties evaluation, a certain amount of ink was loaded on the advanced Peltier Plate to maintain the temperature at 25° C. The upper smooth flat Peltier Plate diameter was 40 mm, and the measurement gap was 500 μm. The shear rate of rheological measurement was controlled from 0.1 s⁻¹ to 1000 s⁻¹. A basic contact angle measuring instrument (SDC-100, Huntech Co., LTD) was used to evaluate the contact angle between the NMP and various solid surfaces.

### Example 11: Electrochemical Characterization

In all the electrochemical measurements, the electrolyte was 1 M LiPF₆ dissolved in EC:EMC (4:6) with 3% FEC. During the assembly, 80 μL of the electrolyte was added to the cell, and Celgard 2325 (25 μm) was used as the separator in the control sample. The active materials mass loading for both Al₂O₃-coated and Celgard paper batteries was approximately 3.55 mg/cm². In addition, galvanostatic tests were performed using LANDTH 8-channel tester, electrochemical impedance spectroscopy was performed using a Biologic SP 150 potentiostat in the frequency range of 1-100 MHz, and cyclic voltammetry was performed using a Biologic MPG2 at a scan rate of 0.1 mV/s.

### REFERENCES

1. Costa, C.; Gongalves, R.; Lanceros-Mendez, S., Recent advances and future challenges in printed batteries. Energy Storage Materials 2020, 28, 216-234.
2. Wang, Y.; Liu, B.; Li, Q.; Cartmell, S.; Ferrara, S.; Deng, Z. D.; Xiao, J., Lithium and lithium-ion batteries for applications in microelectronic devices: A review. Journal of Power Sources 2015, 286, 330-345.
3. Ni, J.; Dai, A.; Yuan, Y.; Li, L.; Lu, J., Three-dimensional microbatteries beyond lithium ion. Matter 2020, 2 (6), 1366-1376.
4. Ni, J.; Li, L., Self-supported 3D array electrodes for sodium microbatteries. Advanced Functional Materials 2018, 28 (3), 1704880.
5. Sun, K.; Wei, T. S.; Ahn, B. Y.; Seo, J. Y.; Dillon, S. J.; Lewis, J. A., 3D printing of interdigitated Li-Ion microbattery architectures. Advanced materials 2013, 25 (33), 4539-4543.
6. Ning, H.; Pikul, J. H.; Zhang, R.; Li, X.; Xu, S.; Wang, J.; Rogers, J. A.; King, W. P.; Braun, P. V., Holographic patterning of high-performance on-chip 3D lithium-ion microbatteries. Proceedings of the National Academy of Sciences 2015, 112 (21), 6573-6578.
7. Pikul, J. H.; Gang Zhang, H.; Cho, J.; Braun, P. V.; King, W. P., High-power lithium ion microbatteries from interdigitated three-dimensional bicontinuous nanoporous electrodes. Nature communications 2013, 4 (1), 1-5.
8. Liu, C.; Gillette, E. I.; Chen, X.; Pearse, A. J.; Kozen, A. C.; Schroeder, M. A.; Gregorczyk, K. E.; Lee, S. B.; Rubloff, G. W., An all-in-one nanopore battery array. Nature Nanotechnology 2014, 9 (12), 1031-1039.
9. Vollmann, H. W., New technologies for the filmless manufacture of printing forms. Angewandte Chemie International Edition in English 1980, 19 (2), 99-110.
10. Kim, S.; Sojoudi, H.; Zhao, H.; Mariappan, D.; McKinley, G. H.; Gleason, K. K.; Hart, A. J., Ultrathin high-resolution flexographic printing using nanoporous stamps. Science advances 2016, 2 (12), e1601660.
11. Zhang, X.; Ju, Z.; Zhu, Y.; Takeuchi, K. J.; Takeuchi, E. S.; Marschilok, A. C.; Yu, G., Multiscale understanding and architecture design of high energy/power lithium-ion battery electrodes. Advanced Energy Materials 2021, 11 (2), 2000808.
12. Zhong, Z.; Ee, J.; Chen, S.; Shan, X., Parametric investigation of flexographic printing processes for R2R printed electronics. Materials and Manufacturing Processes 2020, 35 (5), 564-571.
13. Kusaka, Y.; Koutake, M.; Ushijima, H., High-resolution patterning of silver conductive lines by adhesion contrast planography. Journal of Micromechanics and Microengineering 2015, 25 (9), 095002.
14. Deganello, D.; Cherry, J.; Gethin, D.; Claypole, T., Patterning of micro-scale conductive networks using reel-to-reel flexographic printing. Thin Solid Films 2010, 518 (21), 6113-6116.
15. Wang, Z.; Winslow, R.; Madan, D.; Wright, P. K.; Evans, J. W.; Keif, M.; Rong, X., Development of MnO2 cathode inks for flexographically printed rechargeable zinc-based battery. Journal of Power Sources 2014, 268, 246-254.
16. Schmidt, G. C.; Panicker, P. M.; Qiu, X.; Benjamin, A. J.; Quintana Soler, R. A.; Wils, I.; Hübler, A. C., Paper-Embedded Roll-to-Roll Mass Printed Piezoelectric Transducers. Advanced Materials 2021, 33 (8), 2006437.
17. Hu, L.; Wu, H.; La Mantia, F.; Yang, Y.; Cui, Y., Thin, flexible secondary Li-ion paper batteries. ACS nano 2010, 4 (10), 5843-5848.
18. Zeng, L.; Chen, S.; Liu, M.; Cheng, H.-M.; Qiu, L., Integrated Paper-Based Flexible Li-Ion Batteries Made by a Rod Coating Method. ACS applied materials & interfaces 2019, 11 (50), 46776-46782.
19. Zhu, H.; Narakathu, B. B.; Fang, Z.; Aijazi, A. T.; Joyce, M.; Atashbar, M.; Hu, L., A gravure printed antenna on shape-stable transparent nanopaper. Nanoscale 2014, 6 (15), 9110-9115.
20. Zhu, H.; Jia, Z.; Chen, Y.; Weadock, N.; Wan, J.; Vaaland, O.; Han, X.; Li, T.; Hu, L., Tin anode for sodium-ion batteries using natural wood fiber as a mechanical buffer and electrolyte reservoir. Nano letters 2013, 13 (7), 3093-3100.
21. Gui, Z.; Zhu, H.; Gillette, E.; Han, X.; Rubloff, G. W.; Hu, L.; Lee, S. B., Natural cellulose fiber as substrate for supercapacitor. ACS nano 2013, 7 (7), 6037-6046.
22. Chen, X.; Zhu, H.; Liu, C.; Chen, Y.-C.; Weadock, N.; Rubloff, G.; Hu, L., Role of mesoporosity in cellulose fibers for paper-based fast electrochemical energy storage. Journal of Materials Chemistry A 2013, 1 (28), 8201-8208.
23. Izdebska-Podsiadly, J.; Thomas, S., Printing on polymers: fundamentals and applications. William Andrew: 2015.
24. Hu, G.; Kang, J.; Ng, L. W.; Zhu, X.; Howe, R. C.; Jones, C. G.; Hersam, M. C.; Hasan, T., Functional inks and printing of two-dimensional materials. Chemical Society Reviews 2018, 47 (9), 3265-3300.
25. Susana, L.; Campaci, F.; Santomaso, A. C., Wettability of mineral and metallic powders: applicability and limitations of sessile drop method and Washburn's technique. Powder technology 2012, 226, 68-77.
26. Lee, J.; Lee, C.-L.; Park, K.; Kim, I.-D., Synthesis of an Al₂O₃-coated polyimide nanofiber mat and its electrochemical characteristics as a separator for lithium-ion batteries. Journal of Power Sources 2014, 248, 1211-1217.
27. Liang, X.; Yang, Y.; Jin, X.; Huang, Z.; Kang, F., The high performances of SiO₂/Al₂O₃-coated electrospun polyimide fibrous separator for lithium-ion battery. Journal of Membrane Science 2015, 493, 1-7.
28. Zhang, Z.; Lai, Y.; Zhang, Z.; Zhang, K.; Li, J., Al₂O₃-coated porous separator for enhanced electrochemical performance of lithium sulfur batteries. Electrochimica Acta 2014, 129, 55-61.
29. Li, C.; Xie, Y.; Zhang, N.; Ai, L.; Liang, Y.; Tuo, K.; Ye, X.; Jia, G.; Li, S., Optimization of LiFePO 4 cathode material based on phosphorus doped graphite network structure for lithium-ion batteries. Ionics 2019, 25 (3), 927-937.
30. Zhang, L.; Sun, X.; Hu, Z.; Yuan, C.; Chen, C., Rice paper as a separator membrane in lithium-ion batteries. Journal of Power Sources 2012, 204, 149-154.
31. Wang, Z.; Xiang, H.; Wang, L.; Xia, R.; Nie, S.; Chen, C.; Wang, H., A paper-supported inorganic composite separator for high-safety lithium-ion batteries. Journal of Membrane Science 2018, 553, 10-16.
32. Liu, C.; Wan, L.; Li, Q.; Sun, X.; Natan, A.; Cao, D.; Luan, P.; Zhu, H., Ice-Templated Anisotropic Flame-Resistant Boron Nitride Aerogels Enhanced through Surface Modification and Cellulose Nanofibrils. ACS Applied Polymer Materials 2021, 3 (3), 1358-1367.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A lithium-ion battery comprising a cathode current collector, a cathode, a paper separator having a surface coated with an anti-shorting layer, an anode, and an anode current collector, wherein the cathode current collector is in contact with the cathode, the cathode is in contact with the paper separator, the paper separator is in contact with the anode, and the anode is in contact with the anode current collector.

2. The lithium-ion battery of claim 1, wherein the cathode current collector is aluminum (Al) foil.

3. The lithium-ion battery of claim 1, wherein the cathode comprises sulfur, Li metal oxides, polyanion oxides, stainless steel, LiNiₓMn_{y}Co_{z}O₂ where x+y+z is about 1, or LiFePO4.

4. (canceled)

5. The lithium-ion battery of claim 1, wherein the anode is in contact with the surface of the paper separator coated with the anti-shorting layer.

6. The lithium-ion battery of claim 1, wherein the anode comprises silicon, graphite, alloys comprising tin, cobalt, magnesium, silver, aluminum, and/or antimony, Li4Ti5O12, amorphous carbon, silicon/carbon alloy, lithium oxalates, Li2CO3, and lithium (Li) metal or foil.

7. (canceled)

8. The lithium-ion battery of claim 1, wherein the anode current collector is copper (Cu) foil.

9. (canceled)

10. (canceled)

11. The lithium-ion battery of claim 1, wherein the anti-shorting layer comprises Al₂O₃ or SiO₂.

12. (canceled)

13. The lithium-ion battery of claim 1, wherein the anti-shorting layer has a thickness of about 1 μm to about 30 μm.

14. The lithium-ion battery of claim 1, wherein the lithium-ion battery is flexible.

15. The lithium-ion battery of claim 1, in the form of a microbattery.

16. The lithium-ion battery of claim 1, wherein the cathode is in the form of a two-dimensional or three-dimensional pattern.

17. The lithium-ion battery of claim 1, wherein the cathode current collector, cathode, paper separator, anode, and anode current collector are contained in a sealed container, wherein the paper substrate is first wet with a mixture comprising a liquid electrolyte optionally comprising LiPF6.

18. (canceled)

19. A method of fabricating a lithium-ion battery, comprising:
(i) printing cathode ink onto a first side of a paper separator having a surface coated with an anti-shorting layer and drying the cathode ink, thereby forming a cathode;
(ii) printing anode ink onto a second side of the paper separator and drying the anode ink, thereby forming an anode;
(iii) printing cathode current collector ink on the cathode; and
(iv) printing anode current collector ink on the anode;
thereby fabricating the battery.

20. The method of claim 19, wherein the cathode ink is a flexographic printable ink.

21. The method of claim 19, wherein the anode ink is a flexographic printable ink.

22. The method of claim 19, wherein the printing is roll-to-roll flexographic printing.

23. The method of claim 19, wherein the second side of the paper separator corresponds to the surface of the paper separator coated with an anti-shorting layer.

24. The method of claim 19, wherein the cathode ink is printed in a two-dimensional or three-dimensional pattern.

25. A cathode ink comprising a lithium-based active material, a conductive additive, a binder, and an organic solvent, wherein the ink has a solid content that is about 20 wt. % to about 50 wt. % of the cathode ink.

26. The cathode ink of claim 25, wherein the lithium-based active material, the conductive additive, and the binder in an organic solvent have a mass ratio of about 60:20:20 to about 95:3:2.

27. The cathode ink of claim 25, wherein the lithium-based active material, the conductive additive, and the binder in an organic solvent have a mass ratio of about 80:10:10.

28. The cathode ink of claim 25, wherein the lithium-based active material is LiFePO4 (LFP).

29. The cathode ink of claim 25, wherein the solid content is about 27% to about 40% of the cathode ink dispersion or wherein the solid content is about 35% of the cathode ink dispersion.

30. (canceled)

31. The cathode ink of claim 25, wherein the conductive additive is carbon black, Ketjenblack, and vapor grown carbon fibers or vapor grown carbon nanofibers (VGCF).

32. The cathode ink of f 2 claim 25, wherein the binder is polyvinylidene fluoride (PVDF).

33. The cathode ink of claim 25, wherein the organic solvent is dimethylformamide (DMF) or 1-methyl-2-pyrrolidone (NMP), or a combination thereof.

34. The cathode ink of claim 25, wherein the shear rate of the cathode ink is about 0.1 s⁻¹ to 1,000 s⁻¹.

35. The cathode ink of claim 25, wherein the viscosity of the cathode ink is about 10 Pa s to about 1,000 Pa s at room temperature.

36. The cathode ink of claim 25, wherein the yield stress of the cathode ink is about 1 Pa to about 100 Pa.
